(19) United States
(12) Patent Application Publication
(10) Pub. No.: US 2005/0041679 A1
(43) Pub. Date: Feb. 24, 2005

(54) Method and system for a true-video-on-demand service in a catv network

(76) Inventors: Hillel Weinstein, Haifa (IL); Zeev Orbach, Ashkelon (IL); Baruch Orbach, Ashkelon (IL)

Correspondence Address: HOGAN & HARTSON LLP;IP GROUP, COLUMBIA SQUARE, 555 THIRTEENTH STREET, N.W., WASHINGTON, DC, 20004, US

(21) Appl. No.: 10/492,173

(22) PCT Filed: Oct. 10, 2001
(86) PCT No.: PCT/IL01/00935

(51) Int. Cl. H04N 7/173; H04J 3/26

(52) U.S. Cl. 370/432; 725/100

(57) ABSTRACT

A method and system to be utilized for the provision of a True Video-on-Demand service to paying subscribers of a communication network. The typical T-VoD-specific objectives are accomplished by the optimization of the content distribution efficiency, by the enhancement of the content request options, by the improvement of the content access capabilities, and by the substantially improved handling of content information units. The system and method provides a wide selection of video titles stored on a high-speed high-capacity video object depository within the network. A plurality of video object accessible and transmittable at substantially improved transmission rates are stored temporarily on subscriber equipment devices and enable controllable and dynamic display and interaction including full VCR-like capabilities.

### RELATED APPLICATIONS

The present application is related to co-pending PCT application No. PCT/IL00/00655 by Zeev Averbuch and Dr. Hillel Weinstein entitled “System and Method for Expanding the Operational Bandwidth of a Communication System”, filed 16 Nov. 2000 which is incorporated herein by reference.

### BACKGROUND OF THE INVENTION

1. Field of the Invention

The present invention relates to a method and system for optimizing content distribution efficiency, content request, access, and handling capabilities of a communications network in general; and particularly, although not exclusively, to a method and system for providing an efficient True Video-on-Demand service to subscribers of a cable television network.

2. Discussion of the Related Art

Video-on-Demand (VoD) is an operational concept, which involves three principal parties: a video content owner, a video content service provider and a video content service subscriber. The service involves the upstream transmission of video content requests from a subscriber via a service provider to a content owner, and a downstream delivery of the requested video content from the content owner via the service provider to the service subscriber. The requests and the delivery are transmitted typically as electronically encoded information through specific transmission media such as a hard-wired interface (cable plant), an air Interface (broadcast television), an air-space interface (satellite communications network), any combination thereof, or the like. In order to provide an efficient, practical and commercially viable service within a realistically configured distribution network having a plurality of subscribers requesting a plurality of video objects substantially simultaneously, a number of currently pending technical issues fundamental to the realization of the concept have to be resolved. The issues include the following:
a) enhancing the video content quality as displayed on a subscriber device;
b) expanding the bandwidth capabilities of the existing transmission media;
c) increasing the quantity and the diversity of the video content offered for selection to a subscriber;
d) decreasing the time delay involved in the supply of a specifically selected video content to the subscriber; and
e) resolving the intellectual property issues through appropriate measures such as copy protection, usage supervision and billing management.

The technical term Video-on-Demand (VoD) typically refers to a set of technologies for allowing individuals to select videos from a video server for viewing on suitable display devices such as a television screen, a personal computer display screen, a PDA display, a cellular phone display screen, and the like. VoD can be used for a wide variety of applications such as home entertainment, education, and videoconferencing, to name just a few. Home entertainment could involve the ordering of movies, music videos, or video games to be transmitted digitally to display units installed at the users premises, verbal educational methods could be complemented by viewing training videos ordered and transmitted in a similar manner, and videoconferencing could be made more effective by enhancing traditional presentations with video clips. Although currently VoD is being used to some extent in a number of areas, it is not yet widely implemented. The biggest obstacle to the full implementation of VoD is the lack of a communications network infrastructure that can handle efficiently the large amounts of data required by the simultaneous encoding of a plurality of video objects into electronically transmittable signals.

Currently many cable TV service providers transmit a uniform package of programs associated with a number of channels simultaneously to a plurality of users, who are provided with the option of selecting one channel out of the available channels to view at a particular time. As VoD is considered to have enormous commercial potential to all parties involved both cable TV and telephone operators invest heavily in their native networks in order to carry out trials of substantially interactive VoD services therein. In addition many companies, organizations and universities are developing VoD-related products and standards. In contrast to the currently offered systems that are non-interactive or have limited/pseudo-interactivity, a truly and fully interactive system could provide a much wider selection of programs at any point in time. Based on the level of interactivity provided to a subscriber, VoD services can be classified into several categories:
a) No-Video-on-Demand (No-VoD) that includes broadcast services similar to broadcast TV. In No-VoD the subscriber receives a uniform package of programs and although a specific program can be specifically selected for viewing, within the framework of the selected session the subscriber remains a passive participant and has minimal interactive control over the session;
b) Pay Per View (PPV) are services in which various individual subscribers sign up and pay for a limited number of specific programming events. As with the No-VoD service described above once a subscriber selects a program no further substantial interactivity is provided;
c) Near-Video-on-Demand (Nr-VoD) services in which Individual subscribers are provided the option of selecting specific programming. Limited pseudo-interactivity options are provided such that specific functions like fast forward, reverse, and the like are simulated by transitions in discrete time intervals (on the scale of several minutes). This capability is provided by the utilization of multiple channels through which the same selected programming is transmitted skewed in time; and
d) True-Video-on-Demand (T-VoD) services, in which the subscriber has complete interactive control over the selected programming session presentation. The subscriber is provided full-function virtual VCR capabilities, including fast forward, reverse play, freeze frame, random positioning, and the like. In contrast to Nr-VoD services, T-VoD needs only a single channel per subscriber.

It would be easily understood by one with ordinary skills in the art that the PPV services are the easiest and the T-VoD systems are the most difficult to implement within the existing communications systems infrastructure. Currently PPV services and Nr-VoD services are widely available and are routinely offered by several cable and satellite networks. In order to facilitate the operation of a True Video-on-Demand service first and foremost the operational bandwidth of the content distribution networks must be substantially increased. There is thus a clear and present need for a video distribution system associated with a CATV distribution system, which is equipped with an enhanced user interface, a suitably designed novel local subscriber premises equipment, a bi-directional broadband signal from the user to a centralized video controller and in reverse, a suitably advanced T-VoD management program, a novel video server device, and most importantly an improved electronic infrastructure to support a sufficiently increased operational bandwidth.

### SUMMARY OF THE PRESENT INVENTION

One aspect of the present invention regards a communications network accommodating at least one subscriber linked via a communications network infrastructure to at least one content provider and delivery controller unit, a system of providing the controlled delivery of requested content information between the at least one subscriber and the at least one content provider and content delivery controller unit. The system includes the elements of at least one subscriber equipment unit to enable the at least one network subscriber to submit request information and control information to be transmitted to and to receive controlled content information transmitted from the at least one content provider and content delivery controller unit, a communications plant utilized as a bi-directional information path to a combined information stream including the request information, the control information submitted by the at least one network subscriber, and the controlled content information between the at least one subscriber equipment unit and the at least one content provider and control delivery controller unit, and at least one content provider and content delivery controller unit to receive request and control information from the at least one subscriber equipment unit, to store, select, format, control and deliver the controlled content information to the at least one requesting subscriber equipment unit in order to enable controlled interaction between the at least one network subscriber and the delivered content information.

A second aspect of the present invention regards a communications network accommodating at least one network subscriber connected via a communications network infrastructure to at least one content provider and content delivery controller unit, a method for the controlled transmission of content information units from the at least one content provider and content delivery controller unit to an at least one network subscriber consequent to request information and control information submitted by the at least one network subscriber. The method includes the steps of provisioning the at least one content provider and content delivery controller unit with content information units transmitted from local content provider sources and external content provider sources, submitting content information-related request information and content information interaction-related control information by the at least one network subscriber, receiving and processing content information-related request data and content information interaction-related control data by a billing and channel allocation controller, instructing a content information storage controller unit to extract the requested control information units and transmit the units via an allocated communications channel, and receiving and processing the transmitted content information units by the subscriber equipment unit to enable the at least one network subscriber to display and suitably interact with the information.

A third aspect of the present invention regards a communications network accommodating at least one network subscriber linked to at least one content provider and content delivery controller unit, and a content provider service, and a system for dynamically compressing content information. The system consists of the elements of a digital dynamic compression unit for video movies, a DVD compression unit for Digital Versatile Disks (DVD, and an SSS compression unit for small screen systems.

A fourth aspect of the present invention regards a communications network accommodating at least one network subscriber linked to at least one content provider and content delivery controller unit, and a content information provider service, and a method for dynamically compressing content information. The method consists of dynamically compressing an original digital information unit in order to be utilized In the T-VoD system, compressing a Digital Versatile Disk (DVD) in order to be utilized in the T-VoD system, and compressing an original digital/analog content information unit in order to be utilized in a T-VoD system in a small screen system environment.

### BRIEF DESCRIPTION OF THE DRAWINGS

The present invention will be understood and appreciated more fully from the following detailed description taken in conjunction with the drawings in which:

FIG. 1 is a simplified block diagram illustrating the storage hierarchy of the proposed T-VoD system, in accordance with a preferred embodiment of the present invention; and

FIG. 2 is a simplified block diagram of the T-VoD system as implemented within a XBCS-CATV network, in accordance with a preferred embodiment of the present invention; and

FIG. 3 shows the components of the T-VoD set-top box associated with the CPE and operative in the activation and control of the T-VoD system and method, in accordance with a preferred embodiment of the present invention; and

FIG. 4 illustrates an exemplary remote controller unit operative in submitting subscriber requests for video objects, in accordance with a preferred embodiment of the present invention; and

FIG. 5 illustrates the components operative in enabling the proposed T-VoD system implemented within an XBCS-CATV system to continue the provision of existing CATV services undisturbed, in accordance with a preferred embodiment of the present invention; and

FIG. 6 illustrates an exemplary hardware configuration of the title bank memory, in accordance with the preferred embodiment of the present invention; and

FIG. 7 shows an exemplary list of HDTV-format video object information, in accordance with the preferred embodiment of the present invention; and

FIG. 8 shows an exemplary list of DVB-format video object information, in accordance with a further preferred embodiment of the present invention; and

FIG. 9 is a schematic illustration of the components operative in the provisioning of the title memory bank, in accordance with a preferred embodiment of the present invention; and

FIG. 10A is a table comparing the performance of the video formats supported by the T-VoD system, in accordance with a preferred embodiment of the present invention; and

FIG. 10B is a table comparing the performance of the supported video formats supported by the T-VoD system, in accordance with a further preferred embodiment of the present invention; and

FIG. 11 is a schematic illustration of the components operative in the creation of the dynamic digital compressed video objects, in accordance with a preferred embodiment of the present invention; and.

FIG. 12 shows the various software applications and the related hardware components operative in transforming a standard video object to a substantially compressed video stream, in accordance with a preferred embodiment of the present invention; and

FIG. 13 shows the various software/hardware components operative in transforming a standard video object to a substantially compressed video stream, which is suitable for a Small Screen System (SSS) environment, in accordance with a preferred embodiment of the present invention.

### DETAILED DESCRIPTION OF THE PREFERRED EMBODIMENT

PCT Patent application Serial No. PCT/IL00/00655 by Zeev Averbuch and Dr. Hillel Weinstein entitled “System and Method for Expanding the Operational Bandwidth of a Communication System”, within which a method and system for the substantial expansion of the usable bandwidth of a CATV network is disclosed, is incorporated herein by reference.

PCT Patent application Serial No. PCT/IL00/00655 teaches a method and system for the expansion of the functional bandwidth of a bi-directional symmetrical or asymmetrical multi-user communications system. Information units encoded into electronic signals having diverse content are received at a specific transmission center from a plurality of transmitting information sources. The received signals are suitably processed, frequency-mapped into predefined channels across a substantially expanded range of frequencies, multiplexed into a broadband signal modulated across a predefined portion of a substantially increased functional frequency range, and selectively distributed to a plurality of subscribers along a controlled transmission path. Transmission of encoded information units modulated across another predefined portion of the same substantially increased frequency range in the reverse direction, from a plurality of subscribers to the transmission center, is also provided. Along the transmission path diverse components specifically developed for the reduction to practice of the present invention are operative in dynamically manipulating the required physical characteristics of the transmitted signal. The components properly maintain parameters operative in keeping the integrity of the reproducible information encoded in the signal. Existing components are suitably upgraded by the addition of specifically developed add-up components in order to handle the signal modulated across the entire substantially increased transmission bandwidth. The co-pending patent application regards a novel method and system, which are functional in association with a cable communications network having a substantially expanded operational bandwidth. The method and system for the expansion of the operational bandwidth within the cable communications network will be referred to in the text of this document as the Extended Bandwidth Communications System (XBCS). XBCS could be implemented in association with diverse types of communications networks. Where implemented within the framework of cable television network the resulting system is referred to as an XBCS-CATV system

The present invention discloses a system and method for the provision of a true video-on-demand (T-VoD) service. The proposed system and method provide subscribers of an information distribution and delivery system, implemented within a communications network, with the option of dynamically selecting one or more encoded objects to be delivered to the requesting subscribers. Subsequent to the selection process one or more encoded objects are extracted from a substantially large object depository, which includes a plurality of encoded objects dynamically stored and maintained therein. The selection process is performed via a predefined procedure that allows a subscriber to access a dynamically maintained objects identification list, which is organized such as to reflect the current status of the object depository. The object list includes content object-related information, such as content object identification keys, access keys for traffic security, appropriate link values representing the hardware address of the requested object within the object depository, and the like. Subsequent to the access the subscriber is provided with the option of specifying one or more content object-specific records stored within the list. A specified content object-specific record effects the expeditious delivery of the encoded objects pointed at by the content object-specific record to a subscriber terminal equipment in order to enable the subscriber operating the equipment to handle interactively the delivered content objects. The content object depository is periodically and regularly re-provisioned by the addition of new content objects and/or by the replacement of outdated content objects. The provisioning is accomplished by the substantially regular delivery of up-to-date content objects from diverse external content object sources, such as distributed content object depositories associated with diverse communications networks, in order to provide the subscribers with a substantially contemporary inventory. The system and method allow for the delivery, the interaction with and the viewing of variable-size, variable-format, and variable-length content objects. The proposed system and method support efficient distribution by providing a practically simultaneous multiple delivery of a plurality of requested content objects to a plurality of requesting subscribers, close supervision of the operations, automatic billing, split billing, and content object copy protection. Additionally the proposed system and method provides high transmission speeds, and a significantly wide variety of selectable and distributable content objects. The standard operations of the communications network used as the infrastructure for the delivery of the objects, are not interfered with and therefore could continue undisturbed parallel with the operations of the content object distribution. Yet in addition the proposed system and method provides a novel process for the substantial reduction in the transmission bit rates by a significantly improved compression and decompression of the requested and delivered objects.

The present invention discloses a method and system for the distribution of a plurality of video objects within a communication network. In the preferred embodiments of the present invention the communications network is a CATV system and more specifically an XBCS-CATV system. In the preferred embodiment of the present invention, the method and system proposed are used to provide a True Video-on-Demand service for the purpose of home entertainment. Subscribers of the XBCS-CATV system access and interact with video object providing units by submitting suitable requests through specifically developed subscriber interface units to a video title providing component installed within the XBCS-CATV system. The requests are transmitted upstream via the cable plant to hub units associated with the XBCS-CATV network and servicing a plurality of subscribers. The hub units contain video servers, which Include a title memory bank and appropriate video object handling devices. The requests are received by a video title-providing component. In response to the requests, the requested video objects are transmitted from a video title memory bank to the requesting subscribers. A channel allocation unit appropriately calculates the characteristics of the needed video transmission channels. Consequently the video transmission channels associated with the delivered video objects are suitably allocated by a channel allocation unit associated with a microprocessor controller installed within the video server associated with specific hub units of the cable network. Subsequently the requested video objects are delivered downstream fragmented into sequences having dynamically calculated sizes via hybrid fiber-coaxial paths to display devices installed at the premises of groups of subscribers directly linked to the respective hub units.

It will be apparent to one skilled in the art that the following description is provided to facilitate a thorough understanding of the present invention and should not be construed as limiting to other possible embodiments and alternative uses that could be contemplated without departing from the spirit of the invention or the scope of the appended claims. In other preferred embodiments of the present invention diverse other services such as FM radio broadcasts, local, satellite or microwave TV stations, and multi-channel TV programs, could be distributed and delivered. Yet in another preferred embodiment of the present invention, a plurality of diverse channels having a variety of content, format, and purpose could be integrated into a programming package to be delivered and distributed by the cable communications system. Neither does the present disclosure intend to limit the type of the distribution network. In other embodiments of the invention, the distribution network could be a cellular communications network, or any other communication infrastructure operative in connecting diverse communication nodes located at separate remote or semi-remote geographical locations. Furthermore the proposed method and system could provide diverse other bi-directional symmetrical or asymmetrical services such as the deliverance of communications services by utilizing specific gateway devices to conventional or cellular telephone networks, and the like.

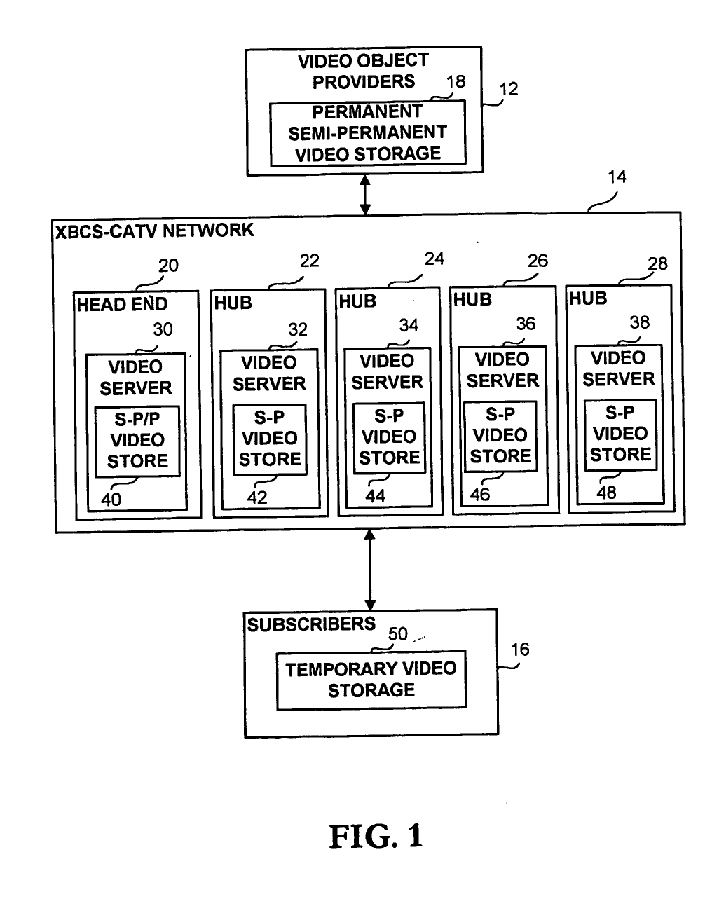

Referring now to FIG. 1 that illustrates the storage hierarchy of the proposed system and method. A video object provider 12 is a central video object-provisioning device, which is operative in the distribution of video objects among diverse video delivery communications networks such as cable television distribution networks. The provider 12 could be associated with a content providing communications network such as a direct broadcast video (DBV) satellite network, or the like. The video object provider 12 includes a permanent or semi-permanent video storage device 18. The video storage device 18 is a central depository of diverse video objects. The video storage 18 could be an automated or a semi-automated tape library, a laser disk library, or a videodisk library. The video objects held by storage device 18 could be suitably stored on different media such as tapes, video disks, laser disks, large disk arrays, Read only Memory (ROM) devices, and the like. It would be easily understood that the video storage 18 could be utilized in a double role such as a) a source unit for the direct distribution of video objects to subscribers and b) as the central unit for the distribution of the video objects among other distribution networks. The storage device 18 could be also an integral part of a cable television network and could be installed in the head end unit or any other appropriate location within the network. Although on the discussed drawing only a single video object provider with a single video storage device is shown it would be easily understood that in a practical configuration a plurality of video object providers could be provisioning a plurality of video delivery networks using a plurality of video storage devices as the source devices. The video object provider 12 is communicatively or permanently coupled to an XBCS-CATV network 14. The network 14 is a cable television network with a substantially expanded transmission bandwidth. The network 14 includes a head end 20, and hub units 22, 24, 26, and 28, which include video servers 30, 32, 34, 36, and 38 respectively. The hub units 22, 24, 26, and 28 provide T-VoD services to a plurality of subscribers. The video servers 30, 32, 34, 36, and 38 each include a semi-permanent video storage unit 40, 42, 44, 46, and 48 respectively. The video storage unit 40, 42, 44, 46, and 48 is a depository of diverse video objects. The video storage 40, 42, 44, 46, and 48 store the video objects on a media, which is designed for rapid access such as a set of high-speed disks with sufficient storage capability. The video storage units 40, 42, 44, 46, and 48 are operative in receiving video objects from the video object providers 12. The video storage units 40, 42, 44, 46, and 48 are also operative in supplying requested video objects to subscribers of the XBCS-CATV network. A plurality of cable network subscribers 16 is coupled to the XBCS-CATV network 14 via the cable plant. The subscribers 16 include a temporary video storage device 50. The device 50 is temporary video storage utilized as a substantially large high-speed video buffer. The device 50 is operative in the storing video objects transmitted from the semi-permanent video storage 40, 42, 44, 46, and 48. The device 50 is preferably a random access device with sufficient storage capability and fast access capabilities. Thus, the proposed system and method provides multi-level storage capabilities. Each level of the storage hierarchy could be configured and organized in a different manner in regard to the storage capability, access time, and storage media, in accordance with the respective functionality thereof. The video objects are transmitted from a higher storage level such as the video object provider to a lower level such as the subscriber, in response to requests submitted on the lower level and transmitted to the appropriate higher level. The subscribers 16 could submit requests for concerning video objects stored on video storage devices 40, 42, 44, 46, and 48 implemented in the video servers 30, 32, 34, 36, and 38 respectively. The video servers 30, 32, 34, 36, and 38 respond to the requests by delivering the requested video objects to the temporary video storage devices 50 of the subscribers 16. The video servers 30, 32, 34, 36, and 38 could introduce requests concerning video objects stored in the permanent or semi-permanent video storage unit 18 implemented by the video object providers 18. The providers 18 respond by delivering the requested video objects to the semi-permanent video storage units 40, 42, 44, 46, and 48 associated with the video servers 30, 32, 34, 36, and 38. Thus a request-driven downstream transport of video objects is achieved within the network where the requests are transmitted upstream from the subscribers 16 via the cable plant to the video servers 30, 32, 34, 36, and 38 associated with the XBCS-CATV head end and hub units 20, 22, 24, 26, and 28, and from the head end and hub units 20, 22, 24, 26, and 28 to the video object providers 18 via suitable interfaces, such as hard-wired communication lines, satellite links, or the like.

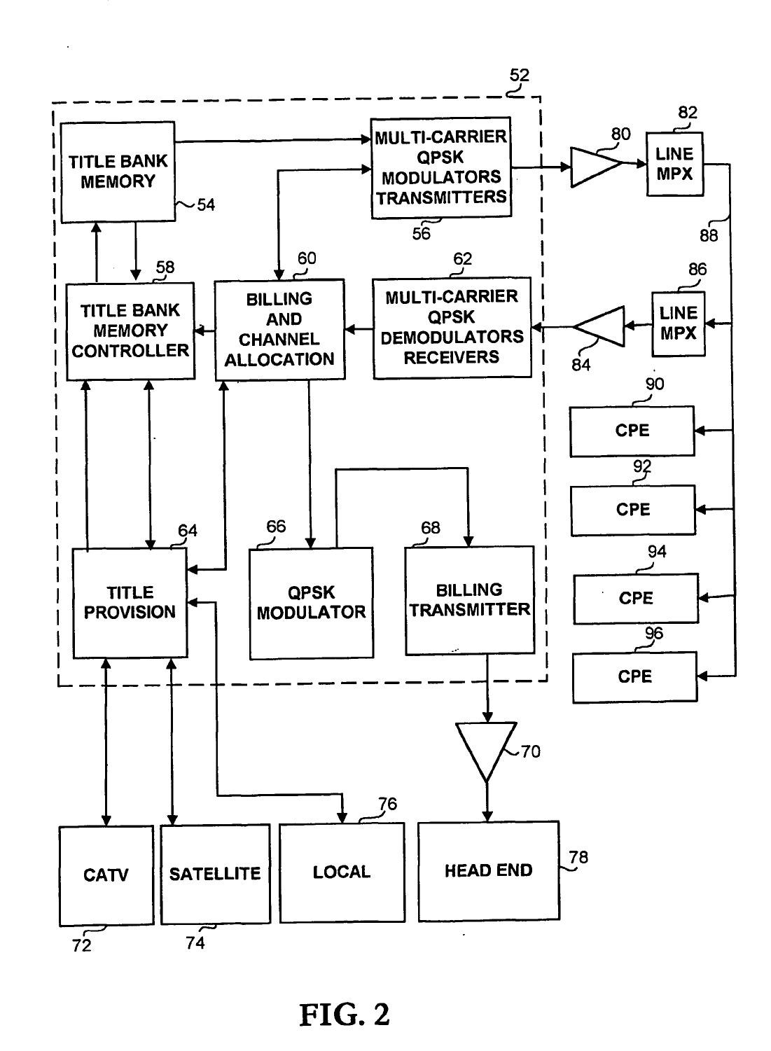

Referring now to FIG. 2 that shows the components of the T-VoD system as implemented within the XBCS-CATV data network. The T-VoD system provides for the semi-permanent storage of the video objects, for determining the characteristics of a transmission channel, for the allocation of the transmission channels, for transmission control, for the delivery of request data and control data upstream, and for video object data delivery downstream from a T-VoD video server 52 to a plurality of Customer Premises Equipment units (CPE) 90, 92, 94, and 96. The video server 52 is provisioned with up-to-date video objects received from diverse external sources such as video content providers via diverse interfaces such as a CATV interface 72, a satellite interface 74, other local programming interfaces 76, and the like. The video server 52 is coupled to the CPE 90, 92, 94, and 96 via fiber and/or coaxial cable 88. The video server 52 contains a video title memory bank 54, a memory bank controller 58, a video title provision component 64, a billing and channel allocation controller 60, multi-carrier Quadrature Phase Shift Keying (QPSK) modulators and transmitters 56, multi-carrier QPSK demodulators and receivers 62, and a billing transmitter 68. In the preferred embodiment of the present invention the video server 52 is installed within one or more hub units and/or the head end unit associated with the XBCS-CATV network. The video server 52 is linked via line amplifier 80, via line multiplexer 82, and the cable 88 to subscribers operating the CPE 90, 92, 94, and 96 for the downstream delivery of a video object. Requests for the delivery of the video objects and control data submitted by the subscribers are transmitted from the CPE 90, 92, 94, and 96 via the cable 88, via the line demultiplexer 86, and via the amplifier 84 to the video server 52. The video server 52 is linked to the XCBS-CATV head end 78 via line amplifier 70. The CPE 90, 92, 94, and 96 includes a specifically developed video-on-demand set-top box (not shown), a data modem (not shown), a television set (not shown), and a remote controller device (not shown). A detailed description of the units constituting the CPE will be provided hereunder In association with the following drawings. In the preferred embodiment of the invention, a conventional CATV network is linked to the hub station that includes the T-VoD video server 52 via an HFC infrastructure specifically modified and upgraded to allow for the appropriate operations of the XBCS-CATV network involving the transmission of a signal having a substantially enhanced bandwidth.

Still referring to FIG. 2 in the preferred embodiment of the invention, title memory bank 54 is the content object depository. Memory bank 54 is responsible for the storage, the indexing, the maintenance, and the retrieval of the video objects stored therein. Memory bank 54 could be an array of memory devices such as high-speed hard disks having sufficient storage capacity to store a substantially large number of video objects. Memory bank 54 is controlled by a set of computer programs constituting specific T-VoD application software, which is installed in title memory controller 58. The billing and channel allocation controller 60 receives requests and control instructions from the subscribers operating the CPE 90, 92, 94 and 96. The controller 60 is a computer processor unit that is responsible for selection of the specified video object, for the billing process associated with the delivery of the video object, for the suitable fragmentation of the selected video object into specific video sequences, for determining the transmission bit rate, for determining the necessary transmission channel frequency, for the allocation of one or more video object transmission channels, and the like. In the preferred embodiment of the present invention the maximum size of a single video object sequence can be set to about 120 MB and the channel frequency rate could be about 48-3000 MHz. In accordance with the requests received from the subscribers, controller 60 interacts in real-time with the subscribers introducing the respective requests. The title bank memory controller 58 accepts the requests with the associated fragmentation instructions from the controller 60, effects the extraction of one or more sequences of the desired video objects from the title memory bank 26 and the delivers the appropriate sequences of the objects downstream to the requesting subscriber operating the CPE 90, 92, 94, and 96 via the transmission channel allocated by the controller 60. The multi-carrier QPSK modulators and transmitters 56 modulate the video object data into radio frequency signals according to the allocated channel and transmit the modulated signal via the amplifier 80, the line multiplexer 82 and the cable 88 downstream to the subscribers. The multi-carrier QPSK modulators and receivers are utilized for the demodulation of the radio-frequency signals received from the subscribers into suitable data format to be processed by the various components of the video server 52. The person skilled in the art would appreciate that other digital modulation methods can be readily employed in this context. The billing portion of the controller 60 is responsible for the performance of predefined billing schemes. The billing portion of the controller 60 could optionally include additional functions, such as customer management, split billing, and the like. It will be easily understood by one with ordinary skill in the art that although only a limited number of CPEs and a single T-VoD video server are shown on the drawing discussed in a realistic environment a plurality of CPE operated by a plurality of subscribers could be operatively linked to a plurality of T-VoD video servers. Thus, at any point in time a plurality of requests for a plurality of video objects could be received, processed, and handled by the video server 52 and consequently a plurality of video objects could-be delivered to a plurality of requesting subscribers.

Subscribers requesting a video object suitably interact with the interface units constituting the CPE 90, 92, 94, and 96. A detailed description of the CPE units and the required procedures for the operation thereof will be set forth hereunder in association with the following drawings. The subscribers submit appropriate requests that are transmitted as radio frequency signals upstream through the cable 88, de-multiplexed by the line demultiplexer 86, amplified by the amplifier 84, demodulated by the multi-carrier QPSK demodulator 62, and delivered to the billing and channel allocation controller 60. The controller 60 receives and processes the requests. The requests include operational information such as the identification of the video object requested, the video object type and definition, the date and time of the request submission, a subscriber identification or CPE address, a subscriber-specific access and authorization code, and other CPE-related technical data such as the size of the video buffer implemented in the CPE. First the controller 60 examines the authorization code in association with the subscriber identification. If the authorization code is valid then the controller obtains the parameters of the requested video object from the title bank memory controller 58. The parameters could include the availability of the object, the size of the video object, and the like. If the video object is available in the title bank memory then if the request regards the initialization of a video object delivery the controller calculates the number of deliverable sequences according to the size of the video object, the storage capability of the subscriber video buffer, the bandwidth assets of the XBCS-CATV network, and the like. A subscriber request-specific control table regarding the video object-specific transmission method is created. The table could include the number of sequences to be delivered, the starting position and the terminating position of each sequence, the sequence index (first, second, and the like) the sequence status (in-delivery, delivered, next, pending, and the like) the channel allocation for the current sequence, and the like. The table could also include specific billing data associated with operational information concerning the delivery of the video object. The controller 60 then obtains from the control table the current sequence to be delivered and instructs the title bank memory controller 58 to extract the appropriate sequence from the title memory bank 54. The video object sequence thus extracted is transmitted via the allocated channel from the title bank memory 54 to the multi-carrier QPSK modulator 52 to be modulated for transmission downstream to the requesting CPE 90, 92, 94, and 96. The channel allocation is determined by the controller 60 for each single sequence. If the request submitted by the CPE 90, 92, 94, and 96 concerns the delivery of a continuation-sequence then the request is processed by the controller 60 by obtaining the suitable sequence record from the suitable control table, allocating a new channel and instructing the title bank memory controller to handle appropriately the next sequence. Thus, a succession of video sequences that constitute a requested video object is transmitted sequentially and periodically to the requesting CPE 90, 92, 94, and 96. Each sequence transmitted downstream is stored in the temporary video storage memory device of the requesting CPE 90, 92, 94, and 96 for viewing and interaction. Consequent to the delivery of the video objects i.e., after the entire set of the sequences thereof is terminated, the controller 60 performs appropriate billing calculations and optionally transmits the billing information to the head end 78 via the QPSK modulator 66, via the billing transmitter 68 and via the cable plant infrastructure.

The provisioning process is performed by an XBCS-CATV network operator (not shown) via the title-provisioning controller 64. The operator initializes the title provisioning process by activating a pre-defined provisioning order stored in the title provision controller 64. The provisioning controller 64 transmits the order to the suitable video object providers 12 of FIG. 1 via the appropriate provisioning interfaces such as the CATV interface 72, the satellite interface 74, and the like. The provisioning order could include the video object providers identification or address, the list of requested titles, a pre-defined video object package identification, suitable access codes for transmission security, the video server 52 identification, the XBCS-CATV network 14 identification and the like. The request is received by the video object providers 12 of FIG. 1 and processed therein. The requested video objects are extracted from the permanent or semi-permanent video storage unit 18 of FIG. 1 and delivered to the provisioning interfaces 72, 74, 76, or the like. The interfaces 72, 74, 76, and the like, deliver the received video objects to the title provision controller 64 which in turn classifies the objects, indexes the objects, determines the existing video objects to be replaced by the just received new objects and instructs the title bank memory controller 58 to update accordingly the title bank memory 54. The title bank memory controller determines the hardware addresses of the video objects, and performs the appropriate delete, add and update operations on the title bank memory device 54. It would be easily understood that the provisioning process could be initiated and performed consequent to a single request of a single subscriber. If a subscriber desires to view a video object that is not available in the title memory bank 54 then in accordance with a pre-defined table including the location of the desired video object the title bank memory controller 58 could activate the title provision controller 64 in order to submit a special request to the suitable video object provider 12 of FIG. 1 concerning the transmission of the object to the video server 52.

The system and method of the present invention deals with a True Video-on-Demand service that can provide a plurality (on the scale of hundreds) of video objects where each object is having a running time of about 90-160 minutes. The initial response time of the delivery system is defined as the period between the points of time a subscriber submits a request to a specific video object and the point of time the video object is delivered and ready for interaction with the subscriber. An approximate initial response time of about one to a few minutes is granted where the variation in the delay is directly proportional with the degree of congestion within the delivery network. The system and method allows selection and delivery of a plurality of video objects stored in multiple formats. As the definition of a video object is relative to the price charged the subscriber is enabled to select a video object in a specific video definition (lowest, low, high, very high) in order to control the cost.

The system and method further include an innovative feature regarding pooled billing. The feature is referred to as the Variable Sequence Dynamic Title Purchaser (VSDTP). The system provides the option of splitting the charge for the delivery of the same video object among several subscribers, which requested and received the object at about the same time. Thus, the original cost of the video object is fragmented into fractions where each of the fractions is charged to the account of a subscriber participating in a pooled request.

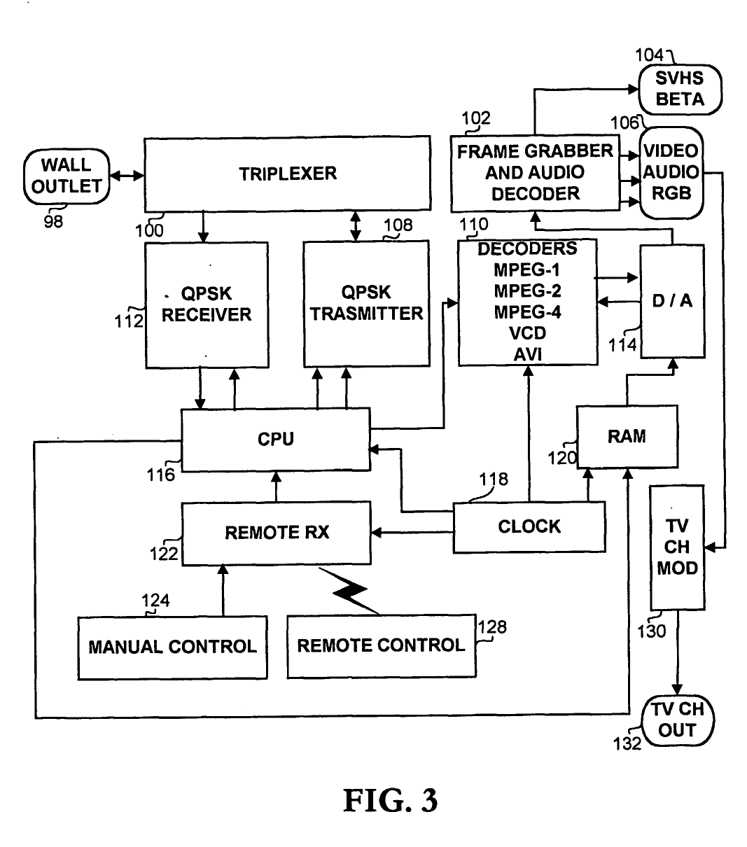

Referring now to FIG. 3 illustrating the configuration of the T-VoD set-top box associated with the customer premises equipment (CPE). The T-VoD set-top box is a stand-alone unit. Power for the set-top box is provided from a separate 12V 1 A regulated power supply, which is double isolated according to the VDE, the ISO, the FCC, and the like standards. The set-top box comprises a triplexer device 100, a QPSK modulator/receiver 112, a QPSK demodulator/transmitter 108, a central processing unit/microprocessor/controller (CPU) 116, a remote receiver unit 122, a manual control device 124, a remote controller device 128, a synchronizing clock unit 118, a decoder unit 110, a frame grabber and audio decoder unit 102, a digital-to-analog converter device 114, a random access memory (RAM) device 120, a television channel modulator 130, a television channel output 132, a video/audio/RGB interface 106, an SVHS/BETACAM interface 104, and a wall outlet interface 98. The triplexer 100 is a set of filters designed to separate the different frequency ranges of the transmitted/received signal. The standard about 5-860 MHz CATV band is routed to the CATV. The about 1-3 GHz bandwidth range routinely provided by the XBCS-CATV network is fed to the QPSK demodulator/receiver 112. The QPSK receiver 112 demodulates the about 103 GHz signal received from the video server. QPSK modulator/transmitter 108 modulates and transmits the signals introduced by the remote transmitter 122 via the CPU 116. The manual controller 124 is a fixed user interface device such as a keyboard, a set of pushbuttons located on the cover of the set-top box, or the like. The remote controller device 128 is a mobile user interface device such as an infrared device. The manual controller 124 and the remote controller 128 are operative in accepting T-VoD-specific instructions submitted by the subscriber and in transmitting the suitably formatted instruction signals to the remote transmitter unit 122. The remote transmitter 122 receives the instruction signals and in turn feeds the signals received to the CPU 116. The CPU 116 is digital device operative in processing signals received, executing instructions, and controlling the operation of the set-top box. The CPU activates a set of software programs responsible for the operation of the set-top box. The software programs could be stored on suitable memory devices (e.g., the RAM 120) or could be embedded as hardware instructions into application specific integrated circuits. The T-VoD-specific instructions introduced by the subscriber via the manual controller 124 or via the remote controller 128 are sent by the CPU 116 to the QPSK modulator/transmitter 108 to the triplexer unit 128. The triplexer 128 filters the received instruction signal and routes the signal modulated into the appropriate frequency range upstream to the video server via the cable plant. The T-VoD-specific instructions are executed by the video server and in response a broadband-signal carrying encoded sequences of the requested video objects is transmitted from the video server downstream to the T-VoD set-top box. The signal is fed to the set-top box through the wall outlet interface 98, filtered by the triplexer in order to route the signal modulated into the appropriate frequency range to the QPSK receiver 112. The signal is demodulated by the QPSK receiver 112, and routed to the CPU 116. The CPU 116 loads the demodulated digital signal representing a sequence of the specific video object in the Random Access Memory (RAM) 120. The RAM 120 is utilized as a video buffer with a sufficient memory capacity (preferably about 128 MB) designed to enable the storage of a maximum-size single video sequence transmitted by the video server. The RAM 120 further provides high processing speed (preferably about 100 MHz) to enable a sufficiently fast access time to the data stored therein. In accordance with the instructions of the subscriber the CPU 116 is operative in initiating the processing of the video object sequence through the reading the stored video data from the RAM 120, and sending the data to the decoder unit 110. The decoder unit 110 includes various video coder/decoder modules (codecs) such as an MPEG-1 codec, an MPEG-2 codec, an MPEG-4 codec, a VCD codec, an AVI codec, and the like. The original format of the video object is recognized by the decoder 110, suitably decoded into the appropriate format, and sent to the digital-to-analog (D/A) transformer device 114. The signal is transformed to an analog waveform by the D/A 114 and fed to the frame grabber and audio decoder 102. The frame grabber captures the image elements encoded into the waveform and converts the images to a format displayable by the television display devices (i.e., NTSC, PAL, or the like). The audio elements of the object are decoded by the unit 102. The unit 102 includes a sound MPEG-1 decoder, a Layer 3 decoder, an AC3 decoder, and the like. The decoding process could provide stereo output, AC3 output, or the like. The composite video and sound could be optionally modulated with an RF carrier. The signal is transferred via the video/audio/RGB interface 106 to the television channel modulator 130 and is fed through the suitable channel through the television channel out interface 132 to the display unit. During the continuous viewing of the video object the subscriber is provided by the option of exercising VCR like control functions such as re-positioning the reading point of the video object by executing a fast forward movement, reverse movement, freezing the current frame, stopping the viewing, replay a specific segment, pausing the viewing, and the like. In the preferred embodiment of the present invention the allowable range of these positioning operations spans the length of the currently stored video object sequence in the RAM 120. In other preferred embodiments the range of the positioning could be extended to the entire length of the video object. The CPU 116 monitors the interaction with the current sequence of the video object stored in the RAM 116. When the reading position of the video object in a substantial proximity to the end-of-file point of the object the CPU 116 automatically initiates the loading of the next sequential sequence of the video object still stored in the video server. Automatic instructions are sent by the CPU 116 via the QPSK modulator/transmitter 108, via the triplexer, via the wall outlet interface 98, via the cable plant to the video server implemented in the hub unit associated with the subscriber. The video server responds by transmitting downstream the next sequential sequence of the video object. The sequence is processed in a similar manner to the manner of operation described hereinabove. The sequentially next sequence is loaded by the CPU 116 into the RAM 120 and partially overwrites the already viewed segments of the current sequence. The final stages of the viewing process of the current sequence and the initial stages of the loading process of the sequentially next sequence are carefully synchronized by the proposed system and method in such a manner that the viewing process of the remaining portions of the current sequence is undisturbed by the loading process of the sequentially next sequence.

Different types of CPUs could be used as the CPU 116 in accordance with the video formats to be used (e.g., MPEG-1, MPEG-2, and MPEG-4) with the transmission bit rates, and with to the sorts of filters utilized

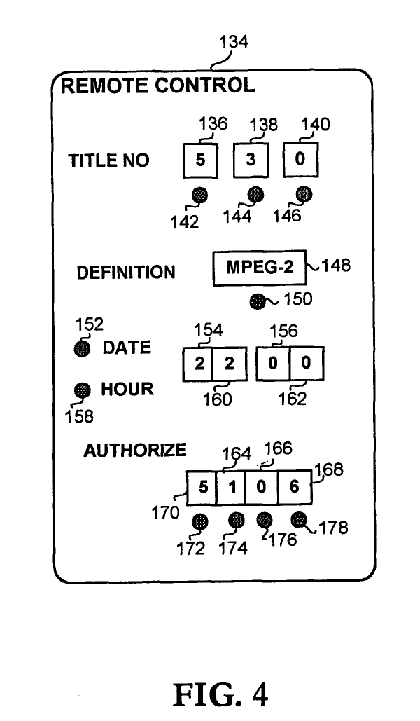

FIG. 4 shows the external view of the remote controller unit 128 of FIG. 3. The remote controller unit 128 is utilized by the subscriber to submit requests for the delivery of video objects to the video server 52 of FIG. 2. In the preferred embodiment of the present invention the subscriber activates the controller 128 of FIG. 3 by operating push buttons and monitoring the process by checking specific LED-type indicator. Thus, the remote controller unit 128 of FIG. 3 includes title number selector buttons 142, 144, 146 and the associated LED-type indicators 136, 138, 149, video object definition selector button 150 and the associated LED-type indicator 148, date/hour selector buttons 152, 158 and the associated LED-type indicators 154, 160, 156, 162, and authorizing code selector buttons 172, 174, 176 and associated LED-type indicators 170, 164, 166, 168. In order to select a video object for viewing the appropriate push buttons are pressed until the desired parameter value is displayed on the LED-type indicators. It would be obvious to one skilled in the art that the above described remote controller unit is exemplary only. The drawing and the description were set forth for the purposes of providing a clear understanding of the proposed method and system and were not intended to be limiting to any conceivable feature that could be contemplated and designed during the process of reduction to the practice of the present invention. For example, positioning control buttons could be added to a practical remote controller device to exercise positioning options, such as fast forward, reverse, frame freezing, stop, pause, rewind, random positioning, repeated replay, and the like. Optionally a specific display window could be provided displaying useful information transmittable from the video server such as billing information, error conditions, and the like. Alternatively some of the selection buttons could be installed on the manual controller 124 of FIG. 3 only. Furthermore, T-VoD-related operational information (such as availability of a specific object), up-to-date billing data, messages, and targeted advertisements could be displayed one the display screen of the television device. The LED-type indicators could be replaced by other type of indicators. As several enhancements relating to the proposed system and method are contemplated even now it is the applicants intention to define and delimit the conceptual and the practical range of the present invention only within the accompanying claims.

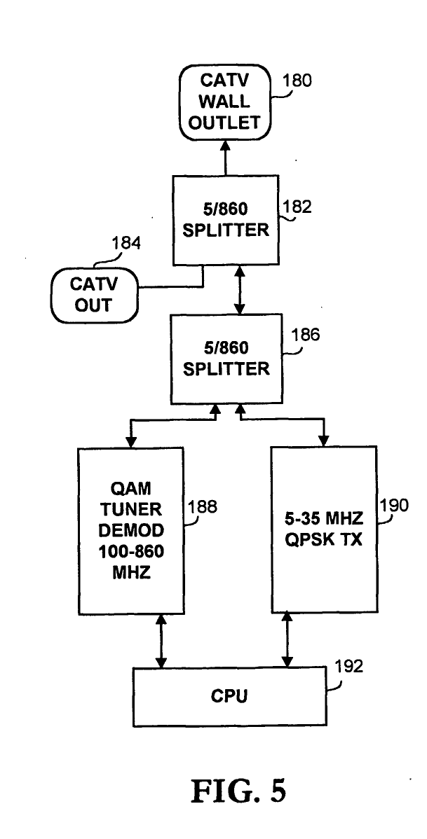

In the preferred embodiment of the present invention the proposed system and method is designed to operate within a cable television distribution and delivery network such as the XBCS-CATV network. It would be easily understood that on of the objectives of the invention is to implement the T-VoD system and method in such a manner as not disturb the existing operations of the network such as the distribution of traditional cable channels, Pay Per View (PPV) movie channels, Near Video-on-Demand (Nr-VoD) channels, and the like. The objective is accomplished by using a pre-determined frequency range for the ordering, controlling and delivery of the T-VoD-specific video objects which frequency range is substantially different from the frequency range utilized by the traditional cable channels. FIG. 5 demonstrates the splitting of the frequency ranges. An XBCS-CATV network can operate with the desired 5-860 MHz spectral range by utilizing the appropriate splitter units 182, 186, a 5-35 MHz QPSK transmitter 190 for upstream transmission of signals from the subscriber, and a 100-860 MHz QAM tuner demodulator for the downstream delivery of the signal from the head end and/or the hub unit to the subscriber.

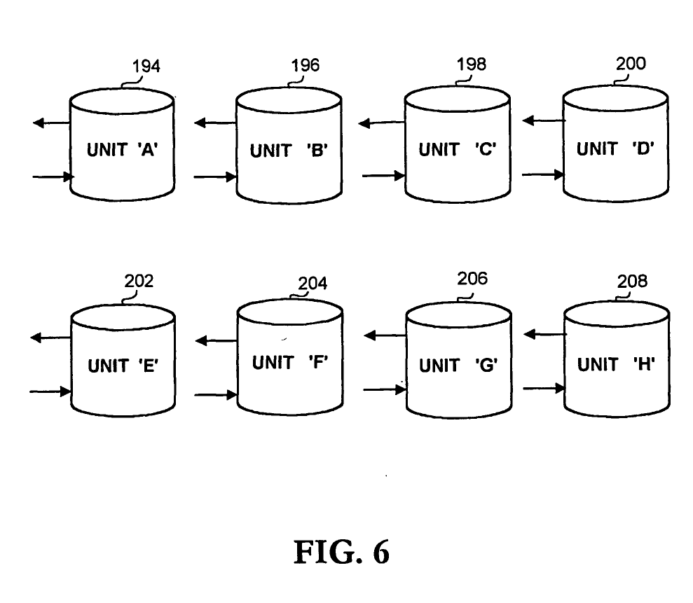

Referring now to FIG. 6 illustrating the hardware configuration of the title bank memory 54 of FIG. 2. Title bank memory 54 of FIG. 2 is the core media bank of the T-VoD video server that includes an array of high-speed hard disks. In the preferred embodiment of the invention, the array consists of a stack of about eight disk units with a preferable capacity of about 75 Gigabyte. The disks are preferably capable of reading speeds of about 40-100 Mb/sec where in the planned embodiments 16 Gb/sec reading speed will be accomplished. The array includes a disk unit ‘A’ 194, a disk unit ‘B’ 196, a disk unit ‘C’ 198, a disk unit ‘D’ 200, a disc unit ‘E’ 202, a disk unit ‘F’ 204, a disk unit ‘G’ 206, and a disk unit ‘H’ 208. The units 194, 196, 198, 200, 202, 204, 206, and 208 include read channels to provide for the transmission of the selected objects to the subscribers. The units 194, 196, 198, 200, 202, 204, 206, and 208 further include write channels to provide for the addition of new video objects. The disk array is operative in holding the video object depository, which includes a plurality (on the scale of hundreds) of video objects stored in various formats, definitions, and sizes. In other preferred embodiments the number of the disk units constituting the array could be larger or smaller. The storage capacity of one or more disk units could also differ in other embodiments in accordance with the overall system configuration.

In accordance with the requirements of the video service providers the hard disk array can store digital video objects in differing formats, and sizes. Preferably the array enables the storage of about 600 GB of high definition television (HDTV) formatted objects at about 27 Mb/sec real time bit transmission rate. Thus, about 16 HDTV video objects are provided to the subscribers to choose from. In an about 100 Mb/sec network application the system will enable an about 4 to 1 transmission time-to-display time speed ratio and in an about 1 Gb/sec network application an about 40 to 1 transmission time -to-display time speed ratio. Only the XBCS-CATV network having an about 12 Gb/sec throughput capable of providing HDTV True-Video-on-Demand with such scales of delivery speed and storage capacity.

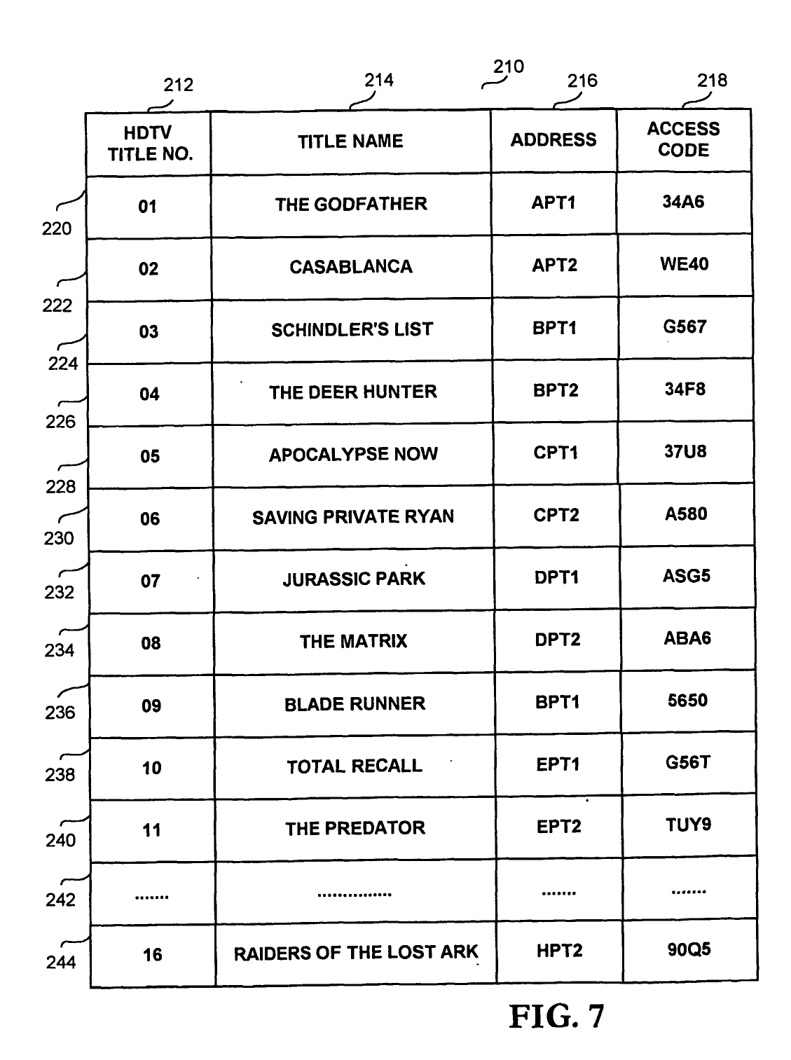

Referring now to FIG. 7 showing an exemplary table consisting of a list HDTV video object information, In accordance with the preferred embodiment of the present invention. The table 210 shown includes video-object-specific 220, 222, 224, 226, 228, 230, 232, 234, 236, 238, 240, 242, and 244. The records 220, 222, 224, 226, 228, 230, 232, 234, 236, 238, 240, 242, and 244 consist of a set of exemplary information fields. Thus, a typical record includes a HDTV title number 212, a HDTV title name 214, a HDTV video hardware address 216, and an access code 218. The HDTV title number 212 indexes the HDTV video object and contains a two-digit number having a value predefined by the T-VoD system administrator. The value could also be determined automatically by the title-provisioning controller 64 of FIG. 2. The HDTV title number 214 is preferably transmitted from the video objects provider 12 of FIG. 1 and is used by the subscribers of the T-VoD system to select a specific video object for delivery. The HDTV title number 214 is further used by the title provision controller 64 of FIG. 2 to handle the video object in accordance with the requests of the subscribers or the T-VoD service operators such as the system administrators in association with the title provisioning process. The HDTV tile name 214 describes the video object in plain text and it is used to identify the video object to the individuals associated with the operation of the T-VoD system such as the system administrators and/or the subscribers. The hardware address 216 is a specific pointer value that indicates the physical location of the HDTV video object within the video object depository or the title bank memory 54 of FIG. 2. The access code 218 utilized as a security code in order to authenticate and authorize access to the specific video object for legitimate subscribers and to block access to unauthorized persons. The table 210 shows a set of records representing the HDTV titles stored in the title memory bank 54 of FIG. 2. For example the first record 220 in the table 210 is indexed by the HDTV title number 212 and is having the value of ‘01’. The HDTV title name 214 displays the description of the object in plain text for example “The Godfather” which is the title of a popular motion picture that could be stored in the title bank memory of a video server installed in a realistically configured T-VoD system. The address 216 points to a specific hardware address ‘APT1 ’ indicating that the specific video object is located on hard disk unit ‘A’ 194 of FIG. 2 within a particular region denoted by the address ‘PT1 ’ for example. The access code 218 is defined as “34A6 ” for example. In order to access the specific video object indexed by ‘01’ the subscriber or the system administrator has to input the access code value ‘34A6 ’ for example. According to the capacity of the hard disk array described above 16 HDTV titles are stored on the title bank memory 54 of FIG. 2. In other preferred embodiments of the invention the number of HDTV titles installed could be greater or smaller relative to the increased or decreased storage capacity of the bank memory 54 of FIG. 2. In other embodiments additional fields could be attached to the records 220, 222, 224, 226, 228, 230, 232, 234, 236, 238, 240, 242, and 244 such as diverse date and time fields, statistical information, status data, and the like.

The hard disk array enables the storage of about 600 GB of Digital Video Broadcast (DVB) formatted objects at about 10 Mb/sec real time bit transmission rate. Thus, about 60 DVB video objects are provided to the subscribers to choose from. In an about 10 Mb/sec network application the system will enable an about 4 to 1 transfer speed ratio and in an about 100 Mb/sec network application an about 10 to 1 transfer speed ratio. Only the XBCS-CATV network having an about 12 Gb/sec throughput capable of providing DVD True-Video-on-Demand with such a delivery speed and storage capacity. Subsequent to the planned upgrades of the current XBCS-CATV network a loading ratio of about 100 to 1 could be achieved.

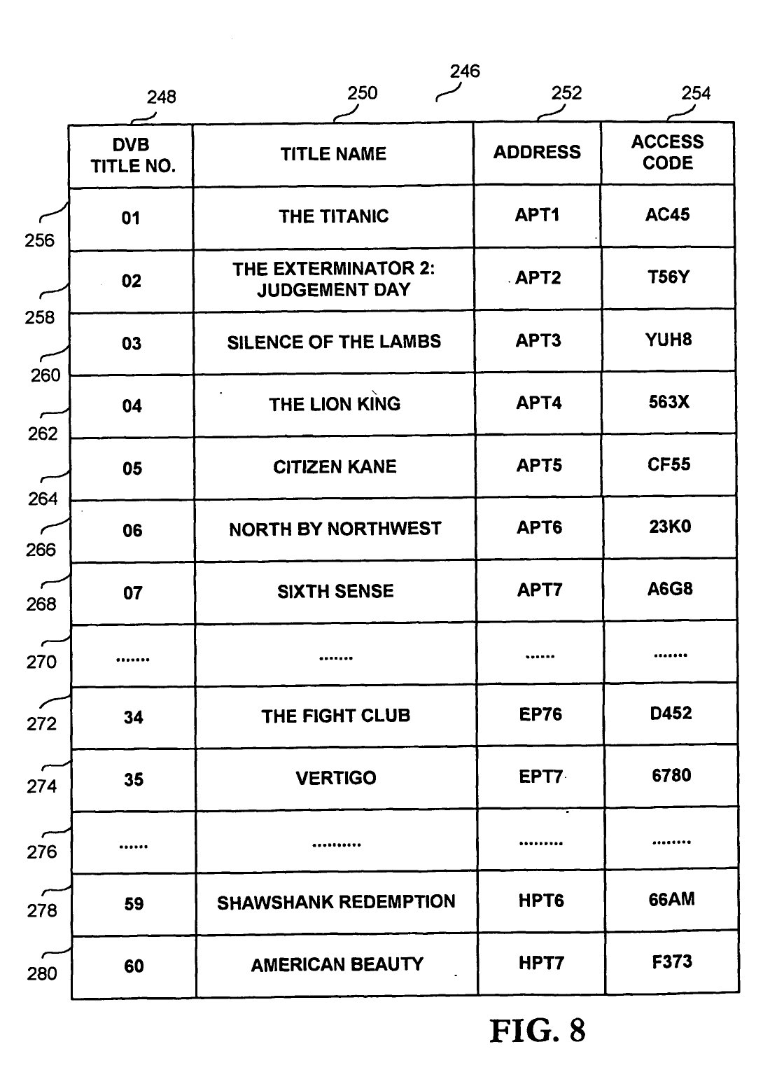

Referring now to FIG. 8 that shows an exemplary table consisting of a list DVB video object information, in accordance with the preferred embodiment of the present invention. The table 246 shown includes video-object-specific records 256, 258, 260, 262, 264, 266, 268, 270, 272, 274, 276, 278, and 280. The records 256, 258, 260, 262, 264, 266, 268, 270, 272, 274, 276, 278, and 280 consist of a set of exemplary information fields. Thus, a typical record includes a DVB title number 248, a video title name 250, a video object hardware address 252, and an access code 254. The DVB title number 248 identifies the video object and contains a two-digit number having a value predefined by the T-VoD system administrator. The title number 248 could be also defined automatically by the title provision controller 64 of FIG. 2. The DVB title number 248 is used by the subscribers of the T-VoD system to select a specific DVB video object for delivery. The title number 248 is further used by the title provision component 64 of FIG. 2 to handle the DVB video object in accordance with the requests of the subscribers or the T-VoD service operators such as the system administrators. The DVB title name 250 describes the video object in plain text and it is used to identify the video object to the individual associated with the operation of the T-VoD system such as the system administrators and the subscribers. The hardware address 252 is a specific pointer value that indicates the physical location of the video object within the video object depository or the title bank memory 54 of FIG. 2. The access code 254 is a security code utilized to authenticate and authorize access to the specific video object for legitimate subscribers and to block access to unauthorized persons. The table 246 shows a set of records representing the DVB titles stored in the title memory bank 26 of FIG. 1. According to the capacity of the hard disk array described above 60 DVB titles are stored on the title bank memory 54 of FIG. 2. In other preferred embodiments of the invention the number of DVB titles installed could be greater or smaller relative to the increased or decreased storage capacity of the bank memory 54 of FIG. 2.

The hard disk array enables the storage of about 600 GB of MPEG-2 formatted objects at about 2.5 Mb/sec real time bit transmission rate. Thus, about 240 different MPEG-2 video objects are provided to the subscribers to choose from. In an about 40 Mb/sec network application the loading speed will be an about 16 to 1 and in an about 100 Mb/sec network application the loading speed will be about 40 to 1. Only the XBCS-CATV network having an about 12 Gb/sec throughput capable of providing MPEG-2 True-Video-on-Demand with such a delivery speed and storage capacity. Subsequent to the planned upgrades on the XCBS-CATV network a title could be delivered from the title memory bank 26 of FIG. 2 to the subscriber within a period of about two seconds.

The high-speed hard disk array enables the storage of about 600 GB of MPEG-4 formatted objects at about 1 Mb/sec real time bit transmission rate. Thus, about 600 different MPEG-4 video objects are provided to the subscribers to choose from. In an about 40 Mb/sec network application the loading speed ratio will be an about 40 to 1 and in an about 100 Mb/sec network application the loading speed ratio will be about 100 to 1. Only the XBCS-CATV network having an about 12 Gb/sec throughput capable of providing MPEG-4 True-Video-on-Demand within such scales of delivery speed and storage capacity. Subsequent to the planned upgrades on the XCBS-CATV network an MPEG-4 title having a running time of about 60 minutes could be delivered from the title memory bank 26 of FIG. 1 to the subscriber within a period of about four seconds. Even in the MPEG-4 format at about 1 Mb/sec transmission bit rate a DVB-like performance of substantially better than VCR definition is achieved. Additionally, a very high-quality 44 KHz stereo sound is obtainable. The addition of diverse video codec filters such as DivX, OpenGL, 3DFX, and the like, allow the MPEG-4 titles to be viewed, listened to, and interacted with in a substantially high quality manner on a large set of suitable devices ranging from low-end computer display screens to large screen television devices.

The hard disk array enables the storage of about 600 GB of VCD MPEG-1 formatted objects at about 1 Mb/sec real time bit transmission rate. Thus, about 600 different MPEG-4 video objects are provided to the subscribers to choose from. In an about 40 Mb/sec network application the loading speed will be an about 40 to 1 and in an about 100 Mb/sec network application the loading speed will be about 100 to 1. Although VCD MPEG-1 video objects are by definition is more suitable to small display screens having a low resolution of 300×300 pixels, the viewing experience provided by the delivery and display of the VCD MPEG-1 files via the proposed system and method is adequate and acceptable.

The hard disk array enables the storage of about 600 GB of AVI formatted objects at about 124 Kb/sec real time bit transmission rate. Thus, about 5600 different AVI video objects are provided to the subscribers to choose from. In an about 24 Kb/sec network application the loading of a full video object will be accomplished in about a few seconds. Typically AVI video objects are more suitable for being viewed on small display screens with a very low resolution. Thus, the delivery and display of AVI video objects is recommended for Personal Digital Assistants (PDA) or for cellular telephone devices.

Thus, in the preferred embodiment of the invention, the system can be configured to allow the title bank memory 54 of FIG. 2 to store simultaneously a plurality of distributable video objects. The following lists present possible storage options:
One) 5600 AVI formatted video objects; or
Two) 600 VCD formatted video objects; or
Three) 600 MPEG-1 formatted video objects; or
Four) 600 MPEG-4 formatted video objects; or
Five) 240 MPEG-2 formatted video objects; or
Six) 60 DVB formatted video objects; or
Seven) 16 HDTV formatted video objects; or
Eight) any combinations of the above options thereof as long as the 600 Gb maximum storage capacity is not exceeded.

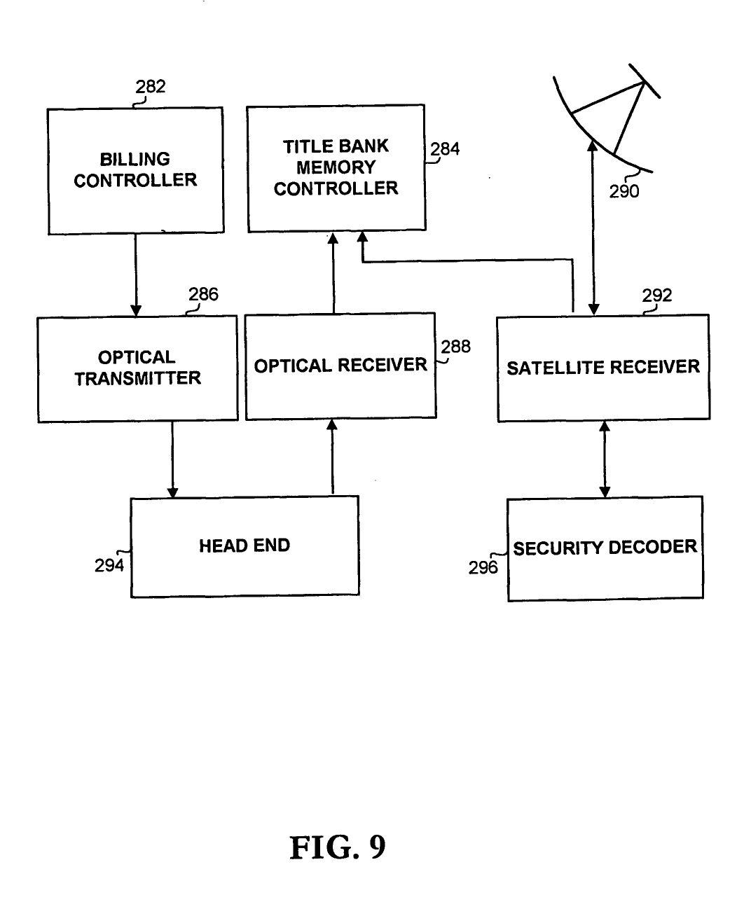

Referring now to FIG. 9 which is a simplified block diagram illustrating the provisioning process of the title memory bank 54 of FIG. The provisioning is the loading of a set of fresh video objects into the title bank memory device 54 of FIG. 2 from the video object providers 12 of FIG. 1. The provisioning could be complete i.e., involving the replacement of the entire set of video object stored previously or partial such as the selective addition of several new video objects to the existing set of video objects. The provisioning could be video-server specific or network-specific. The process could be initiated manually according to the decision taken by the network operator as a result of statistical data regarding the number of requests for the set of video objects. The process could be also periodic such as the refreshing the video object depositories after a specific pre-defined period. Alternatively, in specific cases, the process could be initiated by the video object provider 12 of FIG. 1. Prior to the provisioning process the network operator could determine the number, the format, the type, the running time, and the definition of the video objects to be provisioned in accordance with information regarding available storage space, network bandwidth assets, number of network subscribers (per hub unit), collected usage statistics, and the like. Additionally, individual video objects that were requested frequently by the subscribers but were not available could be requested specifically for special provisioning. Preferably the provisioning process would take place in periods of low network traffic. The video objects designed to be replaced should be access-locked to prevent accidental access from the active subscribers. Alternatively the requests of the subscribers could be re-routed to the video server in the head end 20 of FIG. 1. The principal components involved in the provisioning process will be described next. The process utilizes a billing controller 282, a title bank memory controller 284, an optical transmitter 286, an optical receiver 288, a head end unit 294, a satellite receiver device 292, an antenna device 290, and a security decoder device 296. In the exemplary provisioning process illustrated by the discussed drawing the video object provider 12 of FIG. 1 is associated with a DBV satellite communications network. The provisioning could be performed either directly from a satellite interface 290, 292, 296 installed in the hub unit to the video server associated with the specific hub unit or could be performed indirectly by receiving the objects in the head end 294. In the second case only the head end 294 has satellite interface devices 290, 292, 296 installed. The transmission of the received video objects is accomplished from the head end 294 to the video server installed in the hub unit via the cable plant. It is understood that other preferred embodiments the source of the new video objects could be a video object provider associated with other type of networks.

Still referring to FIG. 9 where direct provisioning is performed the billing controller 282 is operative in the activation of a provisioning list that could include records of video objects required. The records could include a video title, a definition, a security code, and the like. The billing controller 282 instructs the title provision controller (not shown) to transmit a provisioning order accompanied by the provisioning list to the video object provider. Consequently at a pre-determined point in time the provisioning process is initiated in full synchronization with the video object provider. The requested objects are transmitted from the DVB satellite communications network via the antenna device 290 to the satellite receiver 292. The video objects received are decoded by the security decoder and routed to the title bank memory controller 284 that indexes the received objects, establishes addressability by defining hardware addresses for the video objects, and loads the objects to the title bank memory device 54 of FIG. 2. Substantially simultaneously the billing controller prepares appropriate financial records operative in the payment for the received video objects. After the loading of the entire set of objects the billing information is sent to the head end 294 for further handling.

In indirect provisioning the billing controller sends the provisioning list through the optical transmitter 286 to the head end 294. The video objects received at the head end 294 by the video object provider 12 of FIG. 1 are transferred via the cable plant to the video server associated with the hub unit. The optical receiver 288 receives the signal carrying the video objects and feeds the signal to the title bank memory controller 284. The controller 284 indexes the received video objects, assigns hardware addresses to the video objects, and loads the video objects into the title bank memory 54 of FIG. 2 at the specific addresses. Substantially simultaneously the billing controller 282 handles the suitable financial records and subsequent to the termination of the provisioning process transfers the records to the head end 294 for further handling.

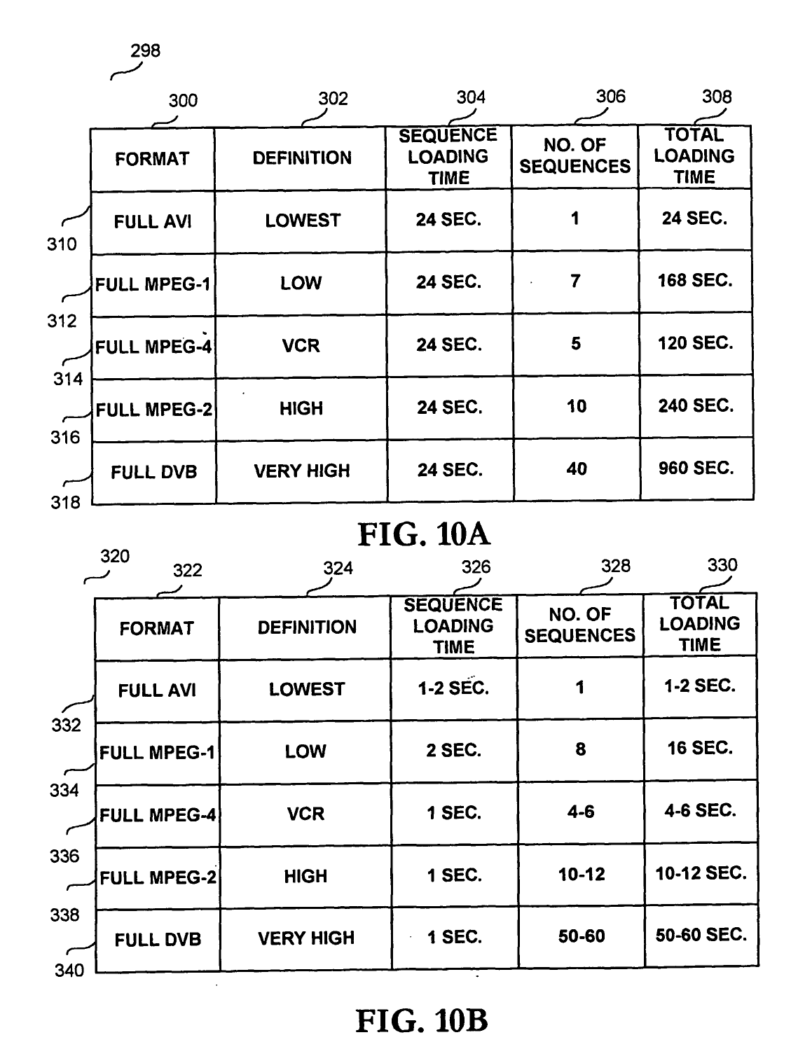

Referring now to FIG. 10A the table 298 shows the loading performance data of the video objects having different formats from the video server to the subscribers RAM. The table 10A refers to loading characteristics via a channel having a bandwidth of about 9 MHz and with a transmission bit rate of 40 Mb/sec. The table 298 is operative in comparing the performance characteristics of the various supported video formats. The table 298 includes format-specific records 310, 312, 314, 316, and 318. The records 310, 312, 314; 316, and 318 include the following format-specific information: a format type 300, a definition 302, a sequence loading time 304, a number of sequences 306, a total loading time 308. The format type 300, and the definition 302 are determined by the requesting subscriber. The number of sequences 306 is determined by the suitable calculations performed by the billing and channel allocation controller, and the loading times 304, 308 are derived from the size of the video sequence and the hardware borders of the XBCS-CATV. For example, the format 300 of the record 318 is defined as “Full DVB”. The definition 302 of the record 318 is “Very high”. The number of sequences to be transmitted 306 is about 40, where the sequence loading time 304 is given as about 24 seconds. Thus, the total loading time 308 of a video object in full DVB format with a very high definition where fragmented to about 40 separate transmission sequences is a total of about 960 seconds (about 16 minutes). In contrast, the format 300 of the record 314 is defined as “Full MPEG-4”. The definition 302 of the record 314 is “VCR”. The number of sequences to be transmitted 306 is about 5, where the sequence loading time 304 is given again as about 24 seconds. Thus, the total loading time 308 of a video object in full MPEG-4 format with a VCR definition where fragmented to about 5 separate transmission sequences is a total of about 120 seconds (about 2 minutes).

Referring now to FIG. 10B the table 320 shows the loading performance data of the video objects having different formats from the video server to the subscribers RAM. The table 10B refers to loading characteristics via a channel having a bandwidth of about 18 MHz and with a transmission bit rate of 100 Mb/sec. The table 320 is operative in comparing the performance characteristics of the various supported video formats. The table 320 includes format-specific records 322, 334, 336, 338, and 340. The records 322, 334, 336, 338, and 340 include the following format-specific information: a format type 322, a definition 324, a sequence loading time 326, a number of sequences 328, and a total loading time 320. The format type 322, and the definition 324 are determined by the requesting subscriber. The number of sequences 306 is determined by the suitable calculations performed by the billing and channel allocation controller, and the loading times 326, 330 are derived from the size of the video sequence and the hardware borders of the XBCS-CATV. For example, the format 300 of the record 340 is defined as “Full DVB”. The definition 302 of the record 340 is “Very high”. The number of sequences to be transmitted 306 is about 50-60, where the sequence loading time 304 is given as about 1 second. Thus, the total loading time 308 of a video object in full DVB format with a very high definition where fragmented to about 50-60 separate transmission sequences is a total of about 50-60 seconds (about 1 minute). In contrast, the format 300 of the record 336 is defined as “Full MPEG-4”. The definition 302 of the record 336 is “VCR”. The number of sequences to be transmitted 306 is about 4-6, where the sequence loading time 304 is given again as about 1 seconds. Thus, the total loading time 308 of a video object in full MPEG-4 format with a VCR definition where fragmented to about 4-6 separate transmission sequences is a total of about 4-6 seconds.

### Digital Dynamic Compressed Video Movie (DDCVM)

All the types of graphics displayed either on a cathode ray tube (CRT) device, or on a Liquid Crystal Display (LCD) device or on a thin-film transistor (TFT) device consists of a visual array comprising picture cells (pixels). The pixel is smallest addressable unit of an image. The definition of the picture depends on the number of pixels in the array. The more pixels are available in the array the higher the definition achieved. The standard television image at an about 4 to 3 esthetic ratio will have about 600 pixels horizontally and about 450 pixels vertically. As about 64 microseconds are needed for a full line trace, each pixel will be exposed for about 100 nano-seconds, which is equivalent to about 10 MHz. A full display cycle is equals to about 5 MHz, which is the highest video frequency seen on a 600×450 pixels screen. A standard PC monitor provides about 1200 or about 1800 pixels, which allows graphics of about 12 to about 20 MHz video bandwidth. The HDTV format can use up to about 27 MHz of video bandwidth.

If a smaller display area is used such as associated with an about 14-inch or an about 5-inch TV screen, an about 2-inch cellular display screen, an about 4-inch Palm display screen, or the like, then the necessity of having a high frequency video bandwidth is less critical.

The proposed T-VoD system and method deals with the above mentioned parameters. The system accepts digital media processed in any available format such as Telecine, SHVS, DVD, Beta or the like. It is digitized fully by an Avid system (or similar) and then encoded to MPEG-4 format. Another codec such as high and low motion DivX is added, and optionally graphic enhancing is performed by utilizing suitable technologies such as Glide, DirectX, or 3DFx. The compressed and processed media is written into a CD-ROM, a hard disk or both.

The system provides the transforming of a standard about 10 MHz bandwidth video (about 10 Mb/sec transmission bit rate) into an about 1 Mb/sec transmission bit rate for a standard TV image having an array comprising 600×450 pixels. Thus a full 1 hour-length video object such as a motion picture will need no more than about 300 MB of memory. If a lower definition is acceptable an about 100 MB per hour at about 24 0 Mb/sec for smaller TV screens of an about 14-inch will be adequate to perform satisfactorily. For smaller display screens such as cellular phone display screens for example an about 14 Kb/sec bit rate is adequate.

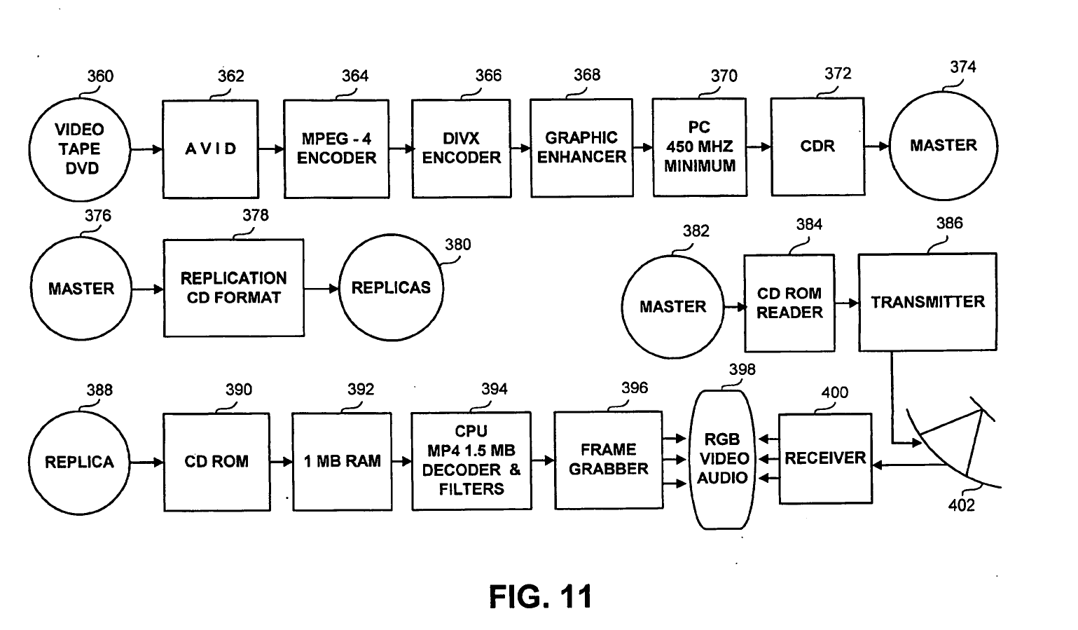

FIG. 11 shows the block diagram of the digital dynamic compressed video movie (DDCVM) processing to record and view via a personal computer display screen. The video object 360 could be a stored in videotape format, DVD format or the like. The object 360 is digitized by the AVID component 362, encoded into MPEG-4 format by an MPEG-4 encoder 364, encoded into DivX format by an DivX encoder component 364, and enhanced graphically by a suitable graphics enhancement component 368. The resulting stream DivX stream is processed by a computer microprocessor and stored on a CD-ROM 372. The object stored on the CD-ROM 372 could be then transferred to a similar or different media to be used as a master copy 374.

Still referring to FIG. 11 the master copy 376, stored in a suitable format such as a DVD format, could be used as input to a replication component 378 that creates video object copies 380 for ordered distribution. The master 382 could also be used as the source intended to be routed to a target such as a subscriber. The master 382 could be utilized by a video object provider associated with a satellite communications network. Thus, the master 382 could be inserted into a CD-ROM reader in order to be re-played and to be unlinked via a satellite transmitter 386, and via a satellite antenna 402 to a communications satellite device in earth orbit (not shown). Specific transponder units (not shown) installed in the satellite device could downlink the video stream to a terrestrial satellite receiver 420 implemented in a satellite interface unit associated with a CPE of a satellite communications network subscriber. The video stream then could be fed to a Video/audio/RGB interface 398 installed on the premises of the subscriber in order to be displayed on a suitable display device.

The replicas 380 are distributed in orderly fashion to various legitimate users. Thus, replica 388 could be delivered to a user to viewing and interaction. The replica 388 could be created and distributed where stored on diverse media such as video tapes, laser disks, DVDs, CD-ROM, or the like. The video object stored on the replica 388 is loaded to a 1 MB RAM 392 via a CD-ROM 390. The microprocessor 394, which includes an MP4 decoder and various filters is operative in reading the video object stored in the RAM 392, in appropriately processing the video object and in feeding the object to a frame grabber 396. The frame grabber 396 converts the digitally encoded object to analog format in order to provide appropriate handling of the object by the display unit of the subscriber. From the frame grabber 396 the analog stream is fed to a Video/Audio/RGB interface 398 to be delivered to and displayed on the subscriber display unit such as a television screen, PC display screen, and the like.

Providing DVD-Like Performance in a T-VoD System

Many currently operative Video-on-Demand (VoD) technologies use MPEG-2 video compression standards, which in order to perform in real-time have to use a stream of about 2.5 to 6 Mb/sec. An about 2.5 MB/sec stream occupies a standard digital TV channel. If a DVD-like performance is desired in the network then the VoD subscriber memory device should be loaded with a video object having the size of about 8 to 9 GB. A video object having such a size will occupy about 20 to 30 digital channels if an about 50 Mb/sec stream will be used giving an about 1 to 10 timing factor (between memory loading duration to playing time). The XBCS-CATV network includes the capability for performing an operation on such a scale.

It would be obvious to one with ordinary skills in the art that current DVD standards are superior to the performance provided by the presently available Video-on-Demand services. The current DVD standards are also significantly superior to the performances provided by the existing CATV standard digital TV channel performances. In order to provide DVD-like performance for a Video-on-Demand service the system and method proposed by the present invention suggests novel approaches and novel technologies related to video enhanced graphics to obtain a DVD-like performance at about 10 to 20 times lower transmission bit rate speeds. Consequent to the achieved lowered bit rates the needed storage capacity of the memory devices could be significantly reduced as well.

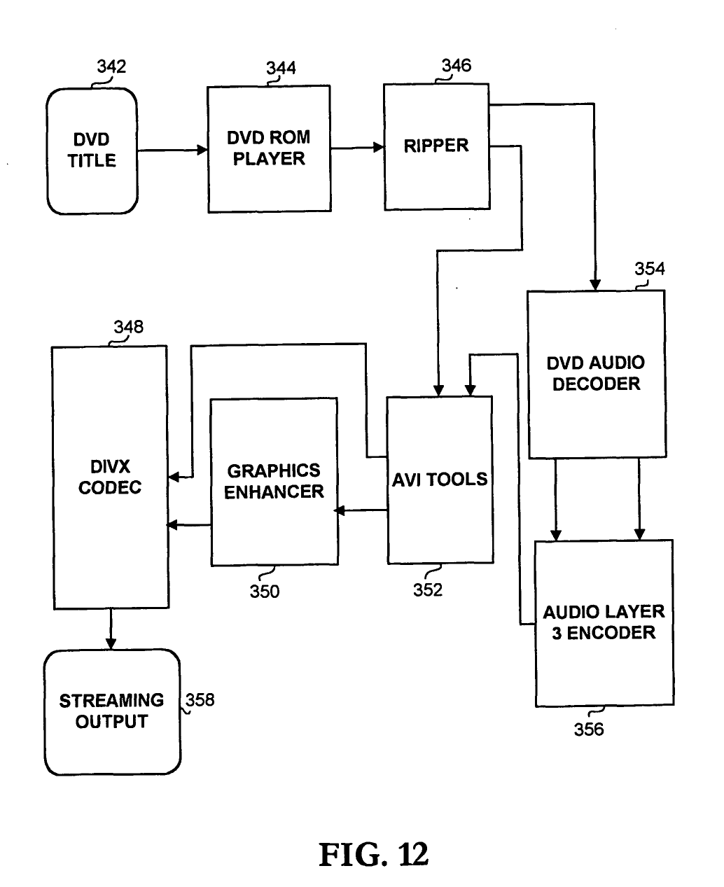

Referring now to FIG. 12 that shows the various software applications and the related hardware components operative in transforming a common available video object to a substantially compressed video stream. A standard DVD format video item 342 is played on a DVD ROM player 344. In traditional DVD operations the DVD object is decoded with a standard DVD MPEG-2 decoder. In the preferred embodiment of the present invention the MPEG-2 decoder is replaced by specific software component 344. The component 344 could be a DVD Ripper, or a DVD Flask MPEG, which are components known in the art. The DVD object 344 is analyzed frame by frame by the component 344 and consequently converted to an AVI format object having a maximum achievable quality. Furthermore the conversion compression impact is reduced to a minimum. Thus, the MPEG-2 configuration is revoked and the original analog-to-digital series stream is built. Consequently the stream is fed into a set of software tools 352 such as the known AVI utilities. The tools 352 could include useful and known graphics-format-handling routines such as the AVI Edit that includes virtual DVB software. The video object stream is captured and processed in order to trim the ends, to clean up the noise if necessary, and perform suitable conversion to accomplish correct sizing of the frame. The tools 352 could also include other graphics-format handling utilities such as the Terabits AVI, which performs statistical calculations regarding the number of frames, aspect ratio, video/audio formats, and the like. Suitable sound system encoding is performed simultaneously with the graphics-handling operations. Thus, the AVI stream is fed into DVD audio decoder 354. Diverse types of audio encoding could be used such as Audio Layer 3 MPEG stereo encoding 356, Dolby surround AC3 encoding (not shown), or the like. A standard CATV digital channel does not provide full stereo sound. Therefore the two full stereo channels that are provided by the proposed method achieve a significant improvement over the existing sound quality of the currently available Video-on-Demand services. The encoded audio stream is fed to the AVI tools 352 to be integrated with the video stream. In order to sharpen the images to their highest Fourier limits the MPEG AVI video components are sent to be handled by a graphics enhancement component 350. The component 350 could utilize known graphics-enhancement technologies such as DirectX, OpenGlide, 3DFX, or the like. Next the MPEG AVI video components from the graphics enhancement component 350 and the audio components from the AVI tools component 352 are fed to a DivX compression/decompression (codec) component 348. The functionality of the component 348 is to encode the MPEG-4 stream into the DivX format. The DivX is a new video format similar to the MP3 format. The DivX codec component 348 lowers the bit rate of the incoming MPEG-4 stream (having at the entry point to the DivX component 348 a substantially large size, such as about 2GB per video object) to about one tenth of its original bit rate speed. DivX compression is operative in the recognition and the differentiation of changes between one frame to the next. This type of compression relates to the optical changes discernible by the human eye viewing an about 12 to 13 frames per second stream. Consequently the DivX processed MPEG-4 includes only about 12 to 13 frames per second. Therefore the DivX multiplexed MPEG-4 video/audio stream enables the downloading of a 100 MB video/audio sequence within a significantly brief period (about 20 seconds at about 50 Mb/sec). As a result playback from the memory device storing the sequence is enabled for about 20 minutes at about 750 Kb/sec. When the playback period is completed the sequentially next video sequence could be loaded into the memory device within a period of about 20 seconds.

Still referring to FIG. 12 a digital video stream and an audio digital stream having diverse formats such as Telecine, VHS, SVHS, Beta, or the like could be handled by the proposed procedure. The resulting streaming output 358 will be similar in all instances to the original input. The output 358 will have transmission bit rates as low as a few Kb/sec for an about 2.5 MHz video such as VHS, or about 120 Kb/sec for an about 5 MHz video such as SVHS.

Providing a T-VoD Service on Small Screen Systems (SSS)

For active display screens having a size of about 8 inches or less the overall area comprises a display array of 160×160 pixels. It was established by the applicants that the subsequent resolution of 25600 pixels is more than adequate for the enjoyment of a motion picture played in an SSS environment. It was further established that in an SSS the original analog or digital media content should be digitized in such a manner that an about 30 Mb per or hour (or less) bit stream is generated. Thus, in an SSS environment the streaming real time bit rate should not exceed 56 Kb/sec, which is the bit rate of a typical modem device. The standard video players incorporated into the operating system packages such as the Windows CE, Palm PC, and the like, which are supplied as supporting software for the existing PDA devices on the market were found by the applicants substantially suitable for receiving and processing the media format in transmitted by the proposed T-VoD system and method. Thus, subsequent to the reduction of the original media to the proposed format via the combination of the DivX codec, and of the Internet IP, the SSS environment is enabled to utilize the T-VoD input with optimal results.

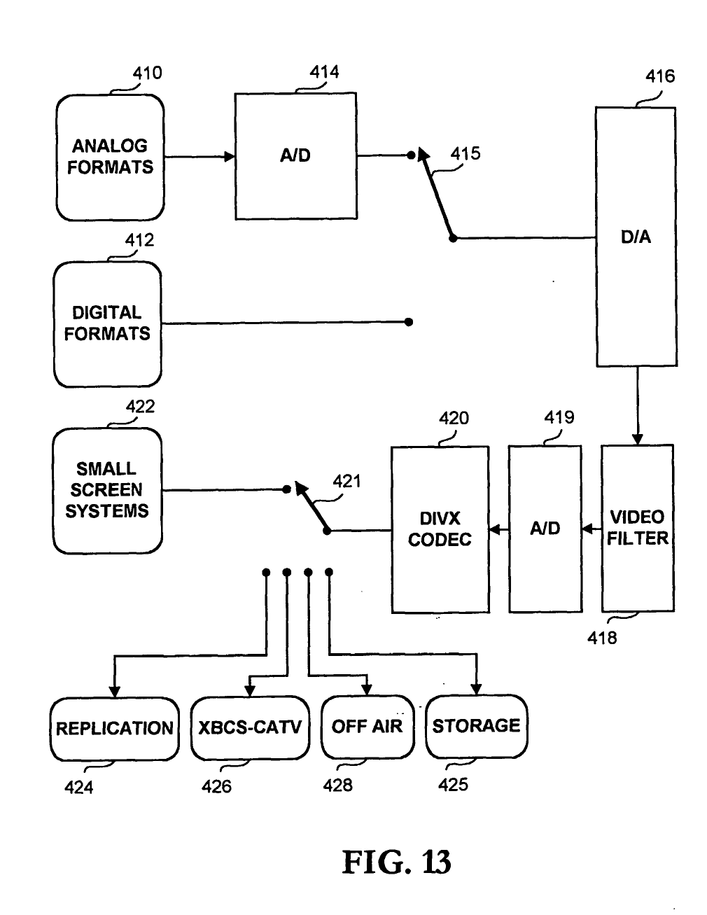

Referring now FIG. 13 that shows the software/hardware components operative in the reduction of the original media format to the proposed substantially compressed video format suitable to an SSS environment. The proposed system and method is capable of receiving various analog formats such as VHS, SVHS, Beta, and the like or digital media having an 8-bit (or higher) format. The analog media formats 410 are converted and digitized in an 8-bit or 16-bit format by an A/D 414. The resulting digital output then fed to a D/A converter 416. The acceptable digital media formats 412 are fed directly to a D/A converter 416. The resulting analog output from the D/A converter 416 is then fed to a video filter 418, which reduces the frequency domains by a factor of about 10. The filtered video stream then fed to an 8-bit A/D converter 419 that drives a DivX codec 420. The output format is the proposed T-VoD bit stream for the SSS environment. The bit stream can be utilized as input media for replication 424, for real time display 422, for storage 425, for real time feed via the XBCS-CATV network 426, or for real time transmission off air via a satellite interface 428. When the SSS environment is a Palm device or an e-book display device then an about 30MB flash memory installable in the SSS device could be fully loaded within a few seconds with a media stream that could provide a playing time of about 60 minutes.

Providing a T-VoD Service on Very Small Screen Systems (VSSS) or Cellular Phones

The very small display screens typically installed in cellular phone devices are having typically a size of about 1 to 3 inches. The screens usually provide a monochrome (B/W) view only and typically comprise a display array of about 100×75 pixels providing a resolution of about 7500 pixels. As the above-mentioned resolution is below the resolution of the human eye the proposed system and method should provide real time streaming bit rate of less than about 14 Kb/sec. Consequently in order to achieve a playing time of about 60 minutes less than about 8 MB storage is needed. These transmission, storage and playing time parameters are substantially sufficient for color displays as well.

Persons skilled in the art will appreciate that the present invention is not limited to what has been particularly shown and described hereinabove. Rather the scope of the present invention is defined only by the claims, which follow.

1. In a communications network accommodating at least one subscriber linked via a communications network infrastructure to at least one content provider and delivery controller unit, a system of providing the controlled delivery of requested content information between the at least one subscriber and the at least one content provider and content delivery controller unit, the system comprising the elements of:
at least one subscriber equipment unit to enable the at least one network subscriber to submit request information and control information to be transmitted to and to receive controlled content information transmitted from the at least one content provider and content delivery controller unit; and
a communications plant utilized as a bi-directional information path to a combined information stream including the request information, the control information submitted by the at least one network subscriber, and the controlled content information between the at least one subscriber equipment unit and the at least one content provider and control delivery controller unit; and
at least one content provider and content delivery controller unit to receive request and control information from the at least one subscriber equipment unit, to store, select, format, control and deliver the controlled content information to the at least one requesting subscriber equipment unit in order to enable controlled interaction between the at least one network subscriber and the delivered content information.

2. The system of claim 1, wherein the at least one subscriber equipment comprises the elements of:
a data modem device to modulate/demodulate the information stream including the request information and the control information introduced by the at least one network subscriber and the controlled content information originated by and delivered by the at least one content provider and content controller unit; and
a set top box to separate and process and process the request information and the control information submitted by the at least one network subscriber in order to be combined into the transmitted information stream and to separate, process, store, and route the content information controllably delivered from the at least one content provider and content controller unit; and
a least one subscriber interface device to accept request information and control information from the at least one network subscriber and to accept and controllably display content information from the at least one content provider and content controller unit.

3. The system of claim 2, wherein the set top box comprises the elements of:
a triplexer device to receive, separate, and suitably route the operative elements of the bidirectional information stream; and
a modulator/receiver unit to receive, and modulate the controllably delivered content information separated and routed by the triplexer; and
a modulator/transmitter to modulate and transmit the request information and control information submitted by the network subscriber; and
a microprocessor/controller device to supervise, control and coordinate the operations of the elements comprising of the set top box; and
a manual/wired controller device to enable the network subscriber to submit request information and control information; and
a remote controller device to enable the network subscriber to submit request information and control information remotely; and
a remote/wired receiver to receive request information and control information submitted by the network subscriber via the manual/wired controller device and the remote controller device; and
a system clock to synchronize the operations of the elements constituting the set top box; and
a storage device to store controllably the content information delivered the at least one content provider and content delivery controller unit; and;
a content format decoder to decode the content information delivered by the at least one content provider and content delivery controller unit; and
a digital-to-analog converter to convert digital content information to analog format; and
a frame grabber to convert the video elements of the content information to a format suitable for display on the at least one subscriber interface device; and
an audio decoder to decode the audio elements of the content information into a format suitable for playing on the at least one subscriber interface device.

4. The system of claim 1, wherein the communications infrastructure comprises the elements of:
a network plant utilized as the transmission media for the delivery of the information stream; and
at least one information processing device to maintain the required characteristics of the information stream including the request information and the control information.

5. The system of claim 4, wherein the communications infrastructure comprises specifically developed passive components to provide for the suitable transmission of the information content carried by an electronic signal having a substantially expanded bandwidth.

6. The system of claim 1, wherein the at least one content provider and content delivery controller unit comprises the elements of:
at least one content storage device for holding a plurality of content information units; and
at least one content storage device controller to control the operation of the at least one content storage device unit; and
at least one content information unit provisioning device to provision the at least one content information storage device; and
at least one billing and channel allocation controller device to receive and process request information and control information from the at least one network subscriber, to allocate transmission channels, to instruct the content storage device controller regarding the controlled delivery of the requested content information unit, and to perform suitable billing functions; and
at least one billing transmitter device to deliver the results of the billing functions to a central accounting data depository and financial application; and
an at least one multi-carrier modulator/transmitter to impress the signals representing the controllably delivered content information unit by suitably modulating a carrier wave according to the instructions of the at least one billing and channel allocation controller device; and
an at least one multi-carrier demodulator/receiver to demodulate the carrier wave transmitted from the at least one network subscriber equipment units in order to extract the signal representing request information and control information, submitted by the at least one network subscriber.

7. The system of claim 1, wherein the communications network is a terrestrial cable television network having a substantially expanded bandwidth transmission capability (XBCS-CATV).

8. The system of claim 1, wherein the controlled content information service requested by the at least one subscriber and delivered by the at least one content provider and content delivery controller unit is a True-Video-on-Demand service.

9. The system of claim 1, wherein content information requested by the at least one network subscriber and controllably delivered by the at least one content provider and content delivery controller device is rich media comprising integrated audio/video information.

10. The system of claim 9, wherein the integrated audio/video information includes a plurality of motion pictures.

11. The system of claim 1, wherein content information requested by the at least one network subscriber and controllably delivered by the at least one content provider and content delivery controller device is rich media comprising video, audio information, video information, text, graphics, applications and data.

12. The system of claim 1, wherein the at least one content provider and content delivery controller unit is installed in a hub unit of the XBCS-CATV network.

13. The system of claim 12, wherein the at least one content provider and content delivery controller unit is installed in the head end unit of the XBCS-CATV network.

14. The system of claim 1, wherein the at least one content provider and content delivery controller unit is communicatively connected to local and external content provider sources.

15. The system of claim 14, wherein the external content provider source is a Digital Video Broadcast satellite network delivering DVB content to the content provider and content delivery controller unit.

16. The system of claim 15, wherein the local content provider source is associated with the head end of the XBCS-CATV network.

17. The system of claim 2, wherein the at least one subscriber interface device is a personal computer device.

18. The system of claim 17, wherein the at least one subscriber interface device is a television device.

19. The system of claim 3, wherein the triplexer device separates the signal representing the information stream into signals having a predefined range of bandwidth.

20. The system of claim 19, wherein the separated signals with the predefined ranges of bandwidth represent standard CATV downstream traffic, T-VoD downstream traffic including controlled content information, standard CATV upstream traffic, and T-VoD upstream traffic including requests and control content submitted by the at least one network subscriber.

21. The system of claim 3, wherein the T-VoD signals are modulated in the Quadrature Phase Shift Modulation (QPSK) technique.

22. The system of claim 3, wherein the microprocessor/controller device is programmed with a set of computer software instructions to enable appropriate control and coordination.

23. The system of claim 22, wherein the set of computer instructions are embedded as firmware in at least one application specific integrated circuit.

24. The system of claim 3, wherein the manual/wired controller device is a keyboard.

25. The system of claim 24, wherein the manual/wired controller device is a control panel including a set of manual controls.

26. The system of claim 3, wherein the remote controller device is an infrared control device including a set of manual controls.

27. The system of claim 3, wherein the storage device is a Random Access Memory (RAM) device.

28. The system of claim 3, wherein the content format decoder includes a set of decoders operative in decoding a variety of video formats.

29. The system of claim 28, wherein the variety of video formats includes an MPEG-1 decoder, an MPEG-2 decoder, an MPEG-4 decoder, a VCD decoder, and an AVI decoder.

30. The system of claim 3 further comprises the elements of:
an AUDIO/VIDEO/RGB interface linked to the television channel modulator; and
a SVHS interface linked to a television channel modulator; and
a Beta interface to link to a television channel modulator; and
a wall outlet to link to the XBCS-CATV infrastructure.

31. The system of claim 4, wherein the at least one information processing device is an amplifier device.

32. The system of claim 1, wherein the communications plant comprises hybrid fiber/optics (HFC) cables.

33. The system of claim 32, wherein the communications plant comprises optical cables.

34. The system of claim 33, wherein the communications plant comprises coaxial cables.

35. The system of claim 1, wherein the information stream comprises a broadband signal having a substantially expanded frequency range.

36. The system of claim 35, wherein the broadband signal is having a bandwidth of about 1050-3000 GHz.

37. The system of claim 36, wherein the expanded bandwidth of about 1050-3000 GHz provides data transfer rates up to about 10 Gbps.

38. The system of claim 6, wherein the content storage device is an array of high-speed, high-capacity disks.

39. The system of claim 6, wherein the billing and channel allocation controller device, the content information unit provisioning device, the billing transmitter device, and the content storage device controller are sets of specifically developed software programs.

40. The system of claim 39, wherein the billing and channel allocation controller device, the content information unit provisioning device, the billing transmitter device, and the content storage device controller are sets of firmware instruction installed into application specific integrated circuits

41. The system of claim 6, wherein the at least one content provider and content delivery controller unit is linked to a line multiplexer, a line demultiplexer, a head end, a local content provider source, a satellite content provider source, and a CATV content provider source.

42. The system of claim 6, wherein the content storage device includes a list of the stored content information units designed to be utilized as control interface data for the at least one network subscriber.

43. The system of claim 42 wherein the list of the stored content information units is designed to be utilized as maintenance control, backup control, and provisioning control data interface for a system administrator.

44. The system of claim 42, wherein the list of stored content information units comprising the elements of:
an information unit index; and
an information unit description; and
an information unit hardware address; and
an access code to provide secure accessing and addressing.

45. The system of claim 6, wherein the content information units stored on the content storage device having a variety of formats.

46. The system of claim 45, wherein the variety of content information formats include HDTV, DVB, MPEG-2, MPEG-4, MPEG-1, VCD, and AVI.

47. The system of claim 6, wherein the content information units stored on the content storage device having different resolutions.

48. In a communications network accommodating at least one network subscriber connected via a communications network infrastructure to at least one content provider and content delivery controller unit, a method for the controlled transmission of content information units from the at least one content provider and content delivery controller unit to an at least one network subscriber consequent to request information and control information submitted by the at least one network subscriber, the method comprising the steps of:
provisioning the at least one content provider and content delivery controller unit with content information units transmitted from local content provider sources and external content provider sources; and
submitting content information-related request information and content information interaction-related control information by the at least one network subscriber; and
receiving and processing content information-related request data and content information interaction-related control data by a billing and channel allocation controller; and
instructing a content information storage controller unit to extract the requested control information units and transmit the units via an allocated communications channel; and
receiving and processing the transmitted content information units by the subscriber equipment unit to enable the at least one network subscriber to display and suitably interact with the information units.

49. The method of claim 48, wherein the step of provisioning comprises the steps of:
determining the suitable content information provider source of the provisioning process; and
coordinating the provisioning process with the content information provider source; and
setting the operational mode of the content information provisioning process; and
initiating the content information provisioning process; and
processing the content information units received from the content information provider source; and
formatting, indexing and storing the received content information units on the content information storage device; and
performing suitable billing transactions regarding the content provisioning source.

50. The method of claim 48, wherein the step of submitting comprises the steps of:
requesting and inspecting the list of the content information units via a suitable subscriber interface and transmitted by the content provider and content delivery controller unit; and
selecting a control information unit for display and interaction with from the list of the inspected control information units; and
introducing control information-specific request data via the suitable subscriber interface to the content provider and content delivery controller unit; and
interacting with the received content information unit in order to controllably display the control information unit on the subscriber display device; and
submitting interaction-specific control information to the content provider and content delivery controller unit in order to accomplish Video Cassette Recorder (VCR)-like controlling options.

51. The method of claim 50, wherein the VCR-like controlling options include the actions of STOP, PAUSE, REWIND, FAST FORWARD, and FAST BACKWARD.

52. The method of claim 48, wherein the step of processing comprises the steps of:
identifying the requested information unit including the associated request parameters; and
obtaining the operational parameters of the requested information unit by the billing and channel allocation controller unit via the content information storage unit; and
obtaining the operational network parameters relating to the availability of the transmission bandwidth, and subscriber equipment storage capabilities; and
allocating a suitable bandwidth for the transmission of the information unit; and
calculating the fragmentation ratio of the information unit according to the obtained network parameters and the request parameters; and
creating a data structure including the appropriate content information unit fragmentation data; and
modifying the data structure including the appropriate content information fragmentation data according to the dynamically transmitted control information received from the at least one network subscriber.

53. The method of claim 48, wherein the step of instructing comprises the steps of:
obtaining the relevant entry in the content information fragmentation data structure including content information unit address, content information unit fragment address, and content information unit fragment length; and
transmitting the content information unit fragment data and the dynamically allocated transmission control data to the content information storage controller; and
ordering the content information storage controller to begin transmission of the relevant content information segment via the dynamically allocated transmission channel.

54. The method of claim 53, wherein subsequent to the dynamically received control information originated by the microprocessor/ controller of the subscriber equipment, the billing and channel allocation controller obtains the next entry in the control information unit fragmentation data structure, obtains and processes the relevant network parameters, dynamically allocates a transmission channel, and re-instructs the content information storage controller to initiate the transmission of the next content information unit segment.

55. The method of claim 53, wherein subsequent to the dynamically received control information from the at least one network subscriber the billing and channel allocation controller unit dynamically instructs the content information storage controller to pause, to stop, to renew and otherwise manipulate the transmission process of the current content information unit segment.

56. In a communications network accommodating at least one network subscriber linked to at least one content provider and content delivery controller unit, and a content provider service, a system of dynamically compressing content information, the system comprising the elements of:
a digital dynamic compression unit for video movies; and
a DVD compression unit for Digital Versatile Disks (DVD); and
an SSS compression unit for small screen systems.

57. The system of claim 56, wherein the elements of the digital dynamic compression unit comprises the elements of:
a convertor unit; and
a replicator unit; and
a delivery unit.

58. The system of claim 57, wherein the element of the convertor unit comprises the elements of:
an original content information unit; and
a digitizer device; and
a first encoder device; and
a second encoder device; and
a graphic enhancer device; and;
a microprocessor/controller device; and
a compact disk recordable (CDR) device.

59. The system of claim 57, wherein the element of the replicator unit comprises the elements of:
a converted master information unit; and
a compact disk replicator device; and
at least one replicated information unit.

60. The system of claim 57, wherein the element of the delivery unit comprises the elements of:
at least one replicated information unit; and
a compact disk read only memory (CD-ROM) device; and
a satellite transmitter device; and
a satellite receiver device; and
a satellite antenna device; and
a random access memory (RAM) device; and
a microprocessor/controller device including decoder and filter devices; and
a frame grabber device; and
a VIDEO/AUDIO/RBG interface device.

61. The system of claim 58, wherein the original content information unit is having a variety of physical and logical storage formats.

62. The system of claim 61, wherein the variety of formats includes video tapes, laser disks, and Digital Versatile Disks (DVD).

63. The system of claim 58, wherein the digitizer device is an AVID device.

64. The system of claim 58, wherein the first encoder device is an MPEG4 encoder device.

65. The system of claim 58, wherein the second encoder device is a DivX encoder device.

66. The system of claim 58, wherein the microprocessor device is about a 450 MHz device.

67. The system of claim 63, wherein the RAM device has the storage capacity of about 1 MB.

68. The system of claim 63, wherein the microprocessor/controller has the storage capacity of about 1.5 MB.

69. The system of claim 58, wherein the first decoder device in an MPEG-4 decoder.

70. The system of claim 56, wherein the element of the DVD compression unit comprises the elements of:
an original DVD-formatted content information interface; and
a Digital Versatile Disk (DVD) player device; and
a DVD ripper device; and
a DVD Audio decoder; and
an Audio Layer 3 encoder device;
a set of graphic tools and enhancer devices; and
a DivX codec device; and
a streaming output interface.

71. The system of claim 56, wherein the element of the SSS compression unit comprises the elements of:
an analog format content information interface; and
a digital format content information interface; and
an analog-to-digital device; and
a digital-to-analog device; and
a video filter device; and
a DivX codec device; and
an content information storage interface; and
a content information delivery satellite interface; and
a XBCS-CATV interface; and
a small screen system (SSS) interface; and
a replication unit interface.

72. In a communications network accommodating at least one network subscriber linked to at least one content provider and content delivery controller unit, and a content information provider service, a method of dynamically compressing content information, the method comprising the steps of:
dynamically compressing an original digital information unit in order to be utilized in the T-VoD system; and
compressing a Digital Versatile Disk (DVD) in order to be utilized in the T-VoD system; and
compressing an original digital/analog content information unit in order to be utilized in a T-VoD system in a small screen system environment.

73. The method of claim 72, wherein the step of dynamically compressing an original digital information unit comprises the steps of:
converting the original digital information unit having a variety of physical and logical formats to a compressed master information unit; and
replicating the compressed master information unit to at least one replicated unit; and
delivering the at least one replicated information content unit to at least one network subscriber.

74. The method of claim 73, wherein the step of converting comprises the steps of:
digitizing the original content information unit; and
encoding the digitized content information unit to the MPEG-4 format; and
encoding the MPEG-4 format content information unit to DivX format; and
graphically enhancing the DivX formatted content information unit; and
processing the resulting information stream by the microprocessor/controller; and
storing the compressed master information unit on a storage unit.

75. The method of claim 72, wherein the step of compressing a Digital Versatile Disk (DVD) comprises the steps of:
inputting a DVD-formatted content information unit to a DVD player device; and
extracting the DVD-formatted content information unit by a DVD ripper device, analyzing the extracted information unit frame by frame and converting the information unit to the AVI format; and
processing the video elements of the AVI-formatted content information unit by specific utilities in order to perform suitable frame sizing, noise reduction and trimming; and
decoding the audio elements of the AVI-formatted content information unit; and
integrating the audio and the video elements of the AVI-formatted content information unit; and
graphically enhancing the content information unit; and
encoding the content information unit into DivX format for suitable compression; and
lowering the frame rate of the content information unit to about 12-13 frames per second; and
outputting the substantially compressed DivX-formatted low frame content information stream.

76. The method of claim 72, wherein the step compressing an original digital/analog content information unit in order to be utilized in a T-VoD system in a small screen system environment comprises the steps of:
inputting a original analog formatted content information unit to an analog-to-digital device; and
inputting an original digital formatted content information unit to a digital-to-analog device; and
substantially reducing the frequency domain of the content information unit stream by filtering the stream with a video filter device; and
converting the content information unit to digital format; and
compressing the content information unit to DivX format; and
outputting the resulting DivX formatted content information unit.

77. The method of claim 776, wherein the step of outputting comprises the steps of:
displaying the compressed content information stream on a small screen system; and
replicating the compressed content information unit; and
delivering the compressed content information unit to the XBCS-CATV network; and
transmitting the compressed content information unit to a satellite network for distribution; and
storing permanently or temporarily the compressed information unit.
